(19) United States
(12) Patent Application Publication
(10) Pub. No.: US 2025/0369601 A1
(43) Pub. Date: Dec. 4, 2025

(54) ADJUSTABLE BRACKET FOR LIGHTING ASSEMBLIES

(71) Applicant: ERICO International Corporation, Solon, OH (US)

(72) Inventor: Michael Hung Sun Oh, Twinsburg, OH (US)

(21) Appl. No.: 19/222,471

(22) Filed: May 29, 2025

Related U.S. Application Data
(60) Provisional application No. 63/654,729, filed on May 31, 2024.

(51) Int. Cl. F21V 21/14; F16M 13/02

(52) U.S. Cl. CPC F21V 21/14; F16M 13/027

(57) ABSTRACT

A support bracket to support a lighting assembly relative can include a centerplate to receive the lighting assembly and a first and second centerplate rail extending along an extension direction. A first bracket member may include a first mounting flange configured to secure the first bracket member to a first building structure and first and second bracket rails extending from the first mounting flange to slidably nest with the first and second centerplate rails, respectively. A second bracket member may include a second mounting flange configured to secure the second bracket member to a second building structure and third and fourth bracket rails extending from the second mounting flange to slidably nest with the first and second centerplate rails, respectively. The bracket rails may be slidably movable within the centerplate rails, to provide a range of extension lengths of the support bracket between the first and second building structures.

### CROSS-REFERENCE TO RELATED APPLICATIONS

This application claims priority under 35 U.S.C. 119 from U.S. Provisional Application No. 63/654,729, filed May 31, 2024, titled “Adjustable Bracket For Lighting Assemblies,” which is incorporated herein by reference in its entirety.

### BACKGROUND

In some contexts, it may be useful to support electrical boxes, luminaires, lighting assemblies, or other objects relative to building structures.

### SUMMARY

Embodiments of the invention can provide an improved telescoping support bracket for supporting a lighting assembly relative to building structures. The support bracket may include a centerplate that integrally includes a support portion. The support portion can include an opening to receive the lighting assembly. The centerplate can integrally include a first centerplate rail extending along an extension direction, and a second centerplate rail extending along the extension direction. The support bracket may include a first bracket member that integrally includes a first mounting flange configured to secure the first bracket member to a first building structure, a first bracket rail extending from the first mounting flange in the extension direction to slidably nest with the first centerplate rail, and a second bracket rail extending from the first mounting flange in the extension direction to slidably nest with the second centerplate rail. The support bracket may include a second bracket member that integrally includes a second mounting flange configured to secure the second bracket member to a second building structure, a third bracket rail extending from the second mounting flange in the extension direction to slidably nest with the first centerplate rail, and a fourth bracket rail extending from the second mounting flange in the extension direction to slidably nest with the second centerplate rail. The first and third bracket rails may be slidably movable within the first centerplate rail, and the second and fourth bracket rails may be slidably movable within the second centerplate rail, to provide a range of extension lengths of the telescoping support bracket to support the centerplate between the first building structure and the second building structure.

Embodiments of the invention can provide an improved support bracket for supporting a lighting assembly. The support bracket may include a centerplate including a support portion. The support portion may include a knockout, the knockout being selectively removable to define an opening to receive the lighting assembly. The centerplate may include a first centerplate rail, the first centerplate rail including a first rectangular tube section extending along the support portion in an extension direction. The support bracket may include a telescoping support assembly. The telescoping support assembly may include a first bracket member having a first bracket rail. The first bracket rail may include a second rectangular tube section nested with the first rectangular tube section of the first centerplate rail along the extension direction. The first bracket rail may be slidably movable relative to the first centerplate rail along the extension direction to adjust a first offset of the lighting assembly from a first building structure. The telescoping support assembly may include a second bracket member. The second bracket member having a second bracket rail. The second bracket rail may include a third rectangular tube section nested with the first rectangular tube section of the first centerplate rail. The second bracket rail may be slidably movable relative to the first centerplate rail along the extension direction to adjust a second offset of the lighting assembly from a second building structure.

Embodiments of the invention can provide a method of supporting a lighting assembly relative to a building structure. The method may include supporting the lighting assembly in an opening of a support portion of a centerplate. The centerplate may include a first centerplate rail extending along an extension direction, and a second centerplate rail extending along the extension direction. The method may include slidably nesting a first bracket rail of a first bracket member of the support bracket with the first centerplate rail and slidably nesting a second bracket rail of the first bracket member with the second centerplate rail, the first bracket member integrally including a first mounting flange configured to secure the first bracket member to a first building structure, the first bracket rail extending from the first mounting flange in the extension direction to slidably nest with the first centerplate rail, and the second bracket rail extending from the first mounting flange in the extension direction to slidably nest with the second centerplate rail. The method may include slidably nesting a third bracket rail of a second bracket member of the support bracket with the first centerplate rail and slidably nesting a fourth bracket rail of the second bracket member with the second centerplate rail, the second bracket member integrally including a second mounting flange configured to secure the second bracket member to a second building structure, the third bracket rail extending from the second mounting flange in the extension direction to slidably nest with the first centerplate rail, and a fourth bracket rail extending from the second mounting flange in the extension direction to slidably nest with the second centerplate rail. The method may include slidably moving the first and third bracket rails within the first centerplate rail, and the second and fourth bracket rails within the second centerplate rail, to provide an extension length selected from a range of extension lengths of the support bracket, to support the centerplate between the first building structure and the second building structure.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is an axonometric view of a support assembly according to an embodiment of the invention;

FIG. 2 is a front elevation view of the support assembly of FIG. 1;

FIG. 3 is a rear elevation view of the support assembly of FIG. 1;

FIG. 4 is a front elevation view of the support assembly of FIG. 1 exploded along lines IV;

FIG. 5 is a rear elevation view of the support assembly of FIG. 1 exploded along lines V;

FIG. 6A is a cross-sectional view of the support assembly of FIG. 1 taken at VI-VI;

FIG. 6B is an enlarged sectional view of portion VIB of the cross-sectional view of FIG. 6A;

FIG. 7 is an axonometric view of an installed assembly including the support assembly of FIG. 1 secured between building support structures in a first configuration;

FIG. 8 is a front elevation view of the installed assembly of FIG. 7;

FIG. 9A is a rear elevation view of the installed assembly of FIG. 7;

FIG. 9B is an enlarged sectional view of portion IXB of the installed assembly of FIG. 9A;

FIG. 10 is a front elevation view of the installed assembly of FIG. 7 including the support assembly of FIG. 1 in a second configuration;

FIG. 11A is a rear elevation view of the installed assembly of FIG. 7 in the second configuration;

FIG. 11B is an enlarged sectional view of portion XIB of the installed assembly of FIG. 11A;

FIG. 12 is a rear elevation view of the support assembly of FIG. 1 in a third configuration;

FIG. 13 is an axonometric view of a support assembly according to an embodiment of the invention in a first configuration;

FIG. 14 is a front elevation view of the support assembly of FIG. 13;

FIG. 15 is a rear elevation view of the support assembly of FIG. 13;

FIG. 16 is a front elevation view of the support assembly of FIG. 13 in a second configuration;

FIG. 17 is a rear elevation view of the support assembly of FIG. 13 in the second configuration;

FIG. 18 is a front elevation view of the support assembly of FIG. 13 in a third configuration;

FIG. 19 is a rear elevation view of the support assembly of FIG. 13 in the third configuration;

FIG. 20 is a front elevation view of the support assembly of FIG. 13 in a fourth configuration;

FIG. 21 is a rear elevation view of the support assembly of FIG. 13 in the fourth configuration;

FIG. 22 is an axonometric view of a support assembly according to an embodiment of the invention in a first configuration;

FIG. 23 is a front elevation view of the support assembly of FIG. 22;

FIG. 24 is a rear elevation view of the support assembly of FIG. 22;

FIG. 25 is a front elevation view of the support assembly of FIG. 22 exploded along lines XXV;

FIG. 26 is a rear elevation view of the support assembly of FIG. 22 exploded along lines XXVI;

FIG. 27A is a cross-sectional view of the support assembly of FIG. 24 taken at XXVII-XXVII;

FIG. 27B is an enlarged sectional view of portion XXVIIB of the cross-sectional view of FIG. 27A;

FIG. 28 is a front elevation view of the support assembly of FIG. 22, in a first configuration;

FIG. 29A is a rear elevation view of the support assembly of FIG. 22, in the first configuration;

FIG. 29B is an enlarged view of portion XXIXB of the support assembly of FIG. 29A;

FIG. 30 is a front elevation view of the support assembly of FIG. 22, in a second configuration;

FIG. 31 is a rear elevation view of the support assembly of FIG. 22, in the second configuration; and

FIG. 32 is a front elevation view of the support assembly of FIG. 22, in a third configuration;

FIG. 33 is a rear elevation view of the support assembly of FIG. 22, in the third configuration.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

The discussion herein is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

In some installations, building codes or other considerations may require that lighting assemblies, electrical boxes, or other components be supported above a floor. In some cases, support brackets can be used to support lighting assemblies or other components between building structures (e.g., from a ceiling structure, specifically between studs of a hard lid ceiling or supports of a T-grid ceiling). Presently, support brackets for supporting lighting assemblies from ceiling structures include monolithic sheet plates. These sheet plate support brackets are generally large, unwieldly, and can be prone to flex, bend, or otherwise perform adversely while supporting lighting assemblies. For example, conventional support brackets may flex and extend into a space in the ceiling meant for drywall, ceiling tile, or other applicable ceiling coverings. As such, installers of ceiling coverings are often required to physically push conventional support brackets upward to create adequate space to install the ceiling coverings, increasing time and effort of installation. Furthermore, monolithic sheet plate support brackets are generally not easily adjustable, requiring workers to permanently cut or otherwise manipulate the sheet plate to reduce its size. As such, sheet plate support brackets are often difficult to install, especially in overhead ceiling applications, and provide little flexibility for installation between variable width ceiling structures. Additionally, monolithic sheet plate support brackets are generally only usable for hard lid ceiling structures, limiting their use in T-bar applications and other ceiling configurations.

Embodiments of the disclosed invention may address these and other issues, including by providing a telescopically adjustable support assembly for lighting assemblies. Providing support assemblies as described below can mitigate potential flexing or other adverse responses of the support brackets to loading, e.g., by utilizing stamped or otherwise rigidly reinforced components. Providing telescopic adjustment as described below can also increase versatility of support brackets, allowing the support brackets to be secured to building support structures that are spaced by different distances from one another. Additionally, telescopically adjustable support assemblies may be easier to install in overhead ceiling applications. For example, adjustable support assemblies as described below can be easily prefabricated, inserted between tees or studs in a ceiling structure, and adjusted to a desired width.

In some embodiments, a support assembly for supporting equipment (e.g., lighting assemblies) between two building support structures (e.g., from studs of a hard lid ceiling, supports of a T-grid ceiling, or other ceiling structures) can include a centerplate and a telescopically adjustable support bracket. The centerplate can include first rail members and a knockout that can receive and retain a lighting assembly. The telescopically adjustable support bracket can include a first bracket member having second rail members, and a second bracket member having third rail members. The rail members of the first and second bracket member can be slidably nested with the first plurality of rail members. For example, the second and third rail members may each include one or more rails that can slidably nest with rails of the first rail members to form one or more corresponding telescopic rails (e.g., each formed by a respective set of nested rails, including a rail of each of the first and second bracket members and a rail of the centerplate). During installation, the first and second bracket members can be slidably adjusted relative to the centerplate and secured to two building support structures that can be spaced apart by a variable range of distances.

In some embodiments, the centerplate can be asymmetric about a centerline of the centerplate that extends substantially perpendicular to the rail members of the centerplate. For example, a center of the knockout of the centerplate can be offset relative to the centerline of the centerplate. In some applications, utilizing a centerplate having an offset knockout can allow a lighting assembly that is supported between a first and second ceiling structure to be offset relative to a centerline between a first and second ceiling structure. For example, offsetting the knockout relative to the centerline of the centerplate may allow installers to telescopically adjust the support assembly to support the lighting assembly adjacent or near a stud or tee in a ceiling structure.

In some embodiments, to help mitigate flexing of the support assembly, the centerplate or the first and second bracket members can include embossments, ridges, or extrusions. For example, a perimeter of the knockout can be extruded or otherwise raised relative to a surface (e.g., a rear surface) of the centerplate. Furthermore, the second rail members of the first bracket member may be connected by a first wall and the third rail members of the second bracket member may be connected by a second wall. The first and second walls may include embossments, ridges, or extrusions, which may increase stability and rigidity of the support assembly.

In some embodiments, to accommodate a supported (e.g., lighting) assembly being adjustably positioned relative to the stud or tee in the ceiling structure, the first and second bracket members may include a cutout. For example, the first bracket member may include the cutout extending between rails of the second rail members (e.g., on the first wall). The cutout may define a width that is greater than or equal to a diameter of the knockout. The second bracket member may include a similar cutout (e.g., on the second wall), and the cutouts may allow the bracket members to be slidably adjusted relative to the centerplate without unwanted interference (e.g., between the bracket members and a lighting assembly secured to the knockout).

In some embodiments, a maximum extension of the support assembly may be regulated by tabs disposed on the various rail members. For example, a first set of tabs of the first rail members may be configured to contact the second and third rail members to provide mechanical resistance to telescopic adjustment of the support assembly. In some cases, the first set of tabs may be configured to contact and engage a second set of tabs of the second or third rail members to provide a mechanical stop to prevent over-extension of the support assembly.

In some embodiments, the second and third rail members may not overlap within the first rail members. For example, the second and third rail members can be separated by a gap within the first rail members. In such nested configurations, the support assembly may advantageously increase a maximum extension length of the support assembly (e.g., between building structures), while reducing the amount of material used to manufacture the support assembly.

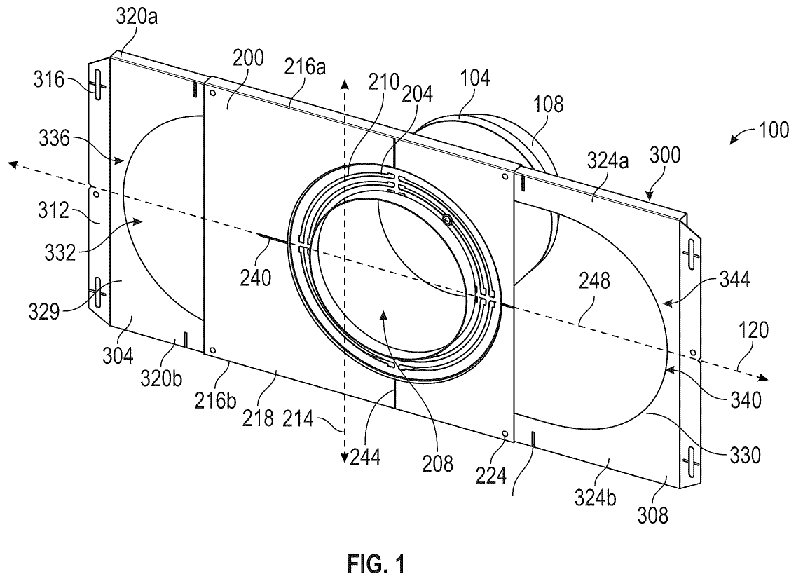

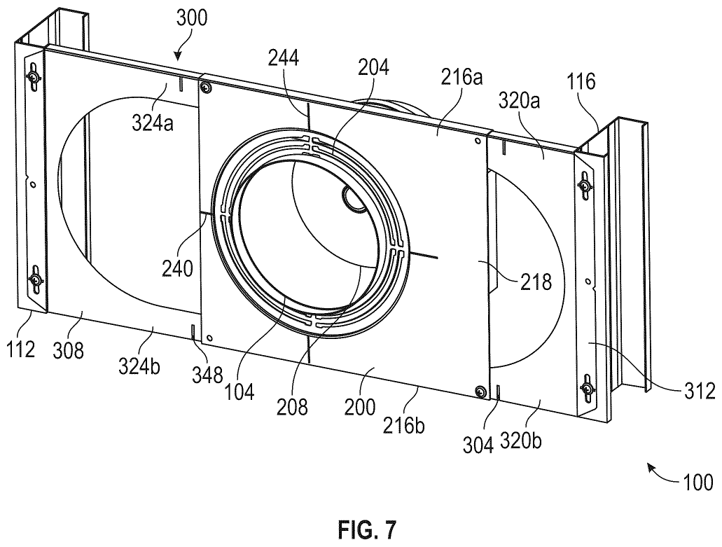

FIGS. 1-3 illustrate an example support assembly (or support bracket) 100 configured to support equipment 104 between a first and second building structure. For example, the support assembly 100 can support a lighting assembly 108 or other electrical assemblies between studs 112, 116 of a hard lid ceiling assembly as shown in FIG. 7, a support member of a T-grid ceiling (not shown), or other ceiling support members. The support assembly 100 can include a centerplate 200 configured to receive and retain the equipment 104. Additionally, the support assembly 100 can include a telescopically adjustable bracket 300, having a first bracket member 304 and a second bracket member 308 that can engage and support the centerplate 200, above a floor of a building (as illustrated in FIG. 7). As will be discussed in greater detail below, adjusting the first bracket member 304 and the second bracket member 308 relative to the centerplate 200 may adjust an extension length of the adjustable bracket 300 along an extension axis 120 or an extension direction (e.g., extending substantially parallel to rails of the centerplate 200).

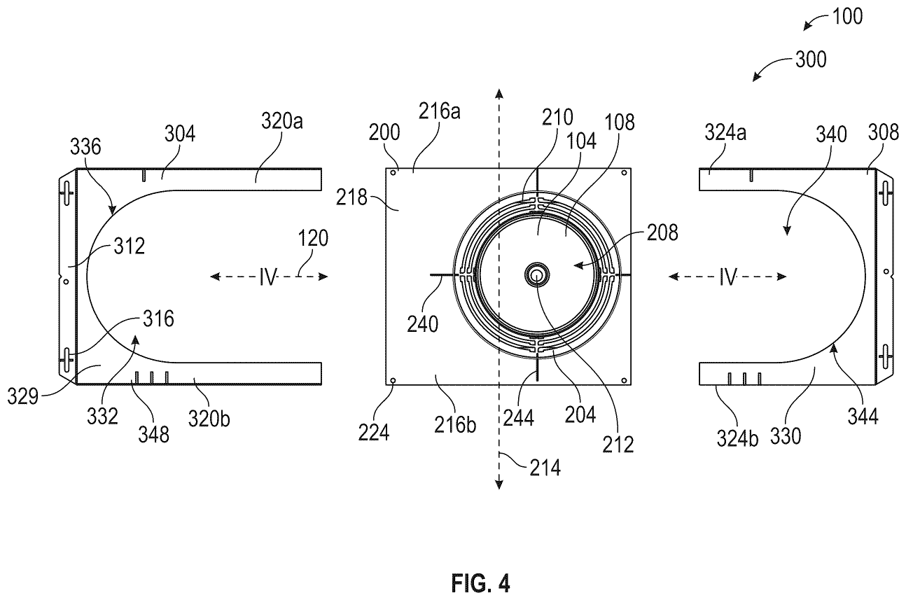

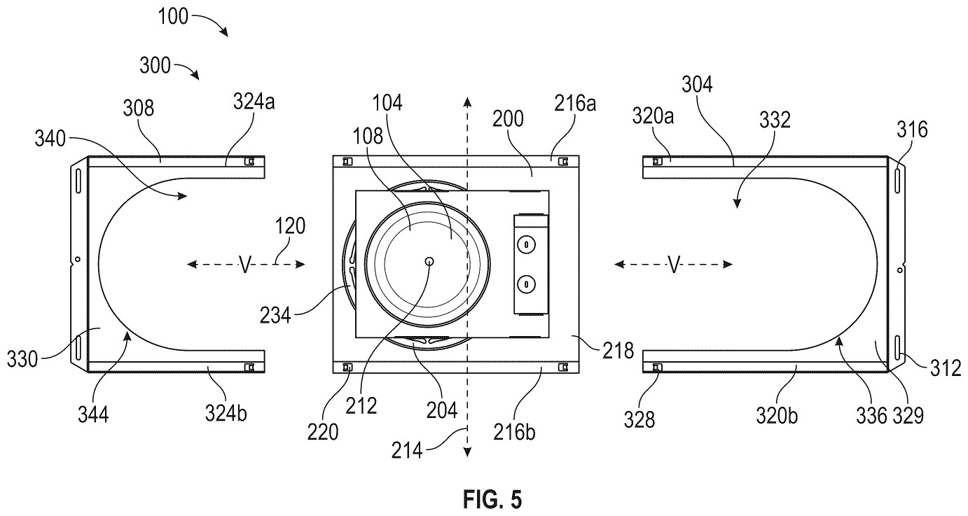

Referring to FIGS. 4 and 5, the centerplate 200 includes a plurality of knockouts 204. For example, the plurality of knockouts 204 can be disposed on the support portion 218. One or more of the plurality of the knockouts 204 can be selectively removed (e.g., cut out) to form an equipment opening 208 to receive and retain the equipment 104. In some examples, the plurality of knockouts 204 may include a plurality of rings 210. For example, each ring of the plurality of rings 210 may be disposed concentrically around a center point 212 of the plurality of rings 210 (or of the knockouts 204). As such, any equipment 104 retained by the equipment opening 208, may share the common center point 212. Furthermore, each ring of the plurality of rings 210 may define a unique radius (e.g., inner radius), which may correspond to applicable sizes of the equipment 104. As such, one or more of the plurality of rings 210 can be selectively removed (e.g., cut out) to enlarge the equipment opening 208, and allow the equipment opening 208 to receive and retain the equipment 104 of various diameters and sizes.

In some examples, the equipment 104 may be secured to the centerplate 200 using one or more fasteners. For example, each ring of the plurality of rings 210 may be spaced apart from an adjacent ring by one or more gaps. The gaps may be configured to receive the fasteners for securing the equipment 104 within the opening 208 and to the centerplate 200.

In some embodiments, the center point 212 may be offset relative to a first centerline 214 of the centerplate 200 that extends through a center of the centerplate 200. In particular, the centerline 214 can extend substantially perpendicular (e.g., perpendicular) to the extension axis 120 within a support plane defined by the centerplate 200 (e.g., can extend horizontally, perpendicular to the extension axis, as installed). Specifically, the center point 212 may be offset relative to the center of the centerplate 200 along the extension axis 120. Thus, for example, the centerplate 200 as a whole may be asymmetric about the first centerline 214.

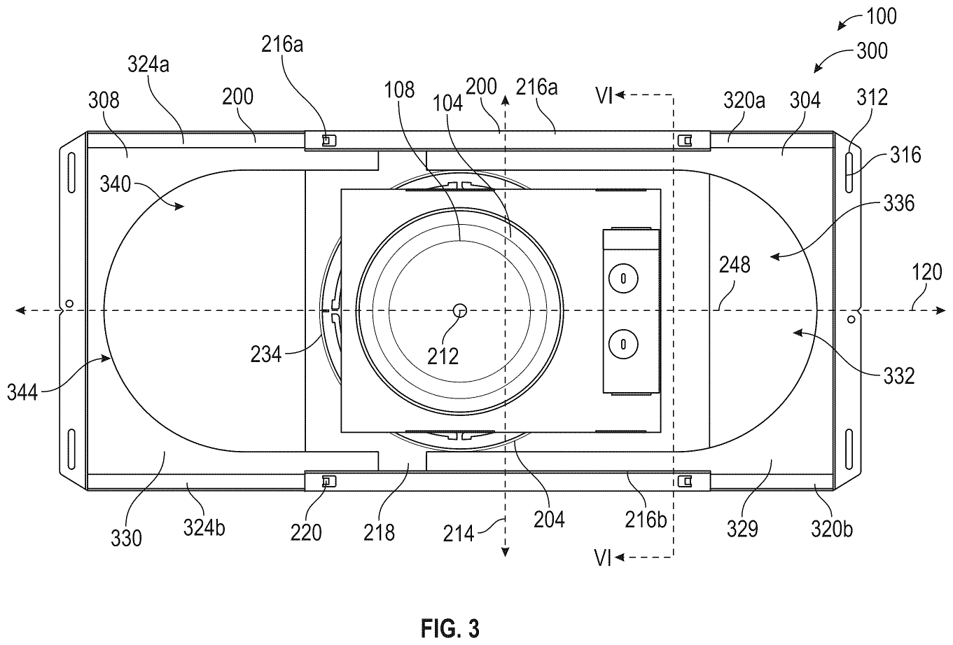

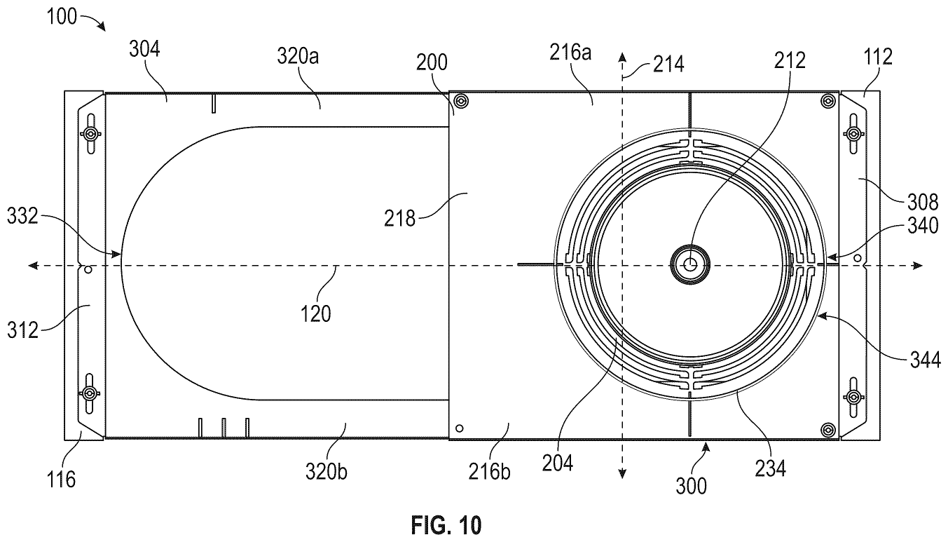

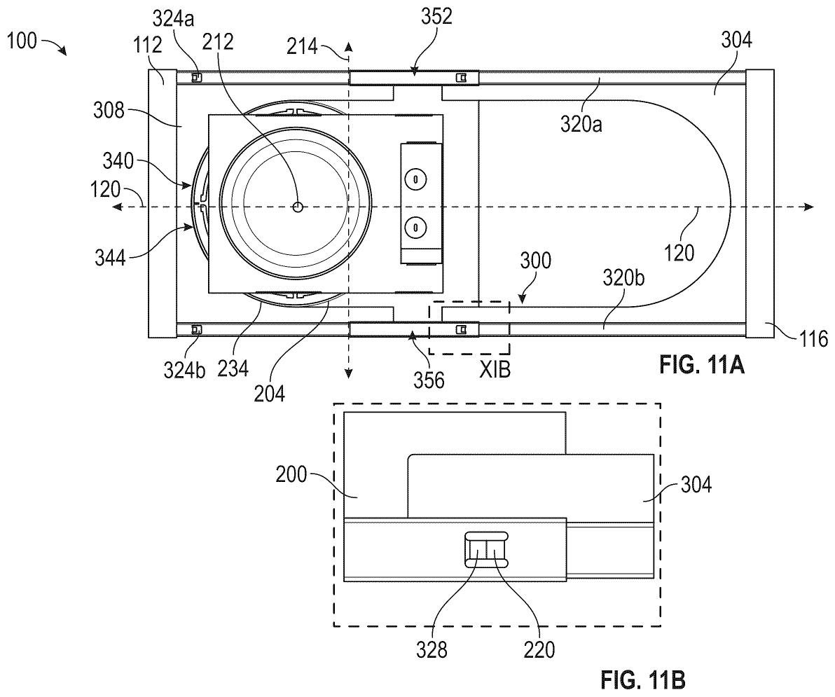

As illustrated in FIG. 3, the offset of the center point 212 may aid the accommodation of asymmetrical equipment. Specifically, in the illustrated example, the lighting assembly 108 may include a light received by the knockouts 204, and an electrical box positioned adjacent to the light. Corresponding to its asymmetrical design, the centerplate 200 may mount (and otherwise accommodate) the electrical box and other components of the lighting assembly 108 on a portion of the centerplate 200 that is opposite the first centerline 214 from the center point 212 of the knockouts 204. The asymmetrical centerplate 200 may thus, for example, reduce a footprint of the centerplate 200 for support of a given electrical assembly by increasing the efficiency of usage of space of the centerplate 200. Furthermore, as will be described below in relation to FIGS. 10-11B, offsetting the knockouts 204 relative to the first centerline 214 of the centerplate 200 may allow installers to telescopically adjust the support assembly 100 to support the lighting assembly 108 (or other equipment 104) in close proximity to the first and second building structure 112, 116.

Still referring to FIGS. 4 and 5, the centerplate 200 can include a plurality of centerplate rail members (e.g., a first plurality of rail members). Specifically, the centerplate 200 includes a first centerplate rail 216a and a second centerplate rail 216b. The centerplate rails 216a, 216b may extend along opposite edges of the centerplate 200. In some embodiments, the centerplate rails 216a, 216b may extend substantially parallel to the extension axis 120, and may be a similar or identical length.

In some examples, a support portion 218 (e.g., a centerplate wall) may extend between the centerplate rails 216a, 216b. The support portion 218 may extend integrally from the centerplate rails 216a, 216b. Furthermore, in some examples, the centerplate rails 216a, 216b may extend along the longest sides or edges of the support portion 228 or the centerplate 200. For example, the first centerplate rail 216a may extend along a first side of the centerplate 200 and the second centerplate rail 216b may extend along a second side of the centerplate 200, opposite the first side. Additionally, the first and second sides of the centerplate 200 may be the longest sides or edges of the centerplate 200. As will be described below, the centerplate rails 216a, 216b may slidably nest with rails of the telescopically adjustable bracket 300 to provide telescopic adjustability to the support assembly 100.

Still referring to FIGS. 4 and 5, as described above, the telescopically adjustable bracket 300 includes the first bracket member 304 and the second bracket member 308 configured to be secured to the first and second building structures 112, 116 (as illustrated in FIG. 7). In different arrangements, different features can be provided on a bracket to secure the bracket to building structures (e.g., different configured from those expressly illustrated). The first and second bracket members 304, 308 can each include a mounting flange 312 with one or more mounting openings 316. As illustrated in FIG. 7, when mounting the support assembly 100 between the building structures 112, 116, fasteners (e.g., screws or other known fasteners) may fasten one or more of the four corners of the telescopically adjustable bracket 300 to the building structures 112, 116. In other contexts, it may be advantageous to utilize only two fasteners or to utilize other known attachment devices for the particular building structure.

In different examples, different types of telescoping arrangements (e.g., rail profiles) can be used. In the illustrated example, the telescopically adjustable bracket 300 includes the two bracket members 304, 308. As described above, the bracket members 304, 308 can include a plurality of first bracket rail members and a plurality of second bracket rail members, respectively.

The first bracket member 304 can include a first bracket member rail 320a and a second bracket member rail 320b. The first and second bracket member rails 320a, 320b may extend along opposite edges of the first bracket member 304. In some embodiments, the first and second bracket member rails 320a, 320b may extend substantially parallel to the extension axis 120 and may be a similar or identical length. In some examples, the first and second bracket rails 320a, 320b can extend integrally from the flange 312 of the first bracket member 304.

Similarly, the second bracket member 308 can include a third bracket member rail 324a and a fourth bracket member rail 324b. The third and fourth bracket member rails 324a, 324b may extend along opposite edges of the second bracket member 308. In some embodiments, the third and fourth bracket member rails 324a, 324b may extend substantially parallel to the extension axis 120, and may be a similar or identical length. In some examples, the third and fourth bracket rails 324a, 324b can extend integrally from the flange 312 of the second bracket member 308.

In some cases, the bracket members 304, 308 (or parts thereof) can be substantially identical, which may, for example, reduce manufacturing steps necessary to produce dissimilar parts, generate material savings in the manufacturing process, and simplify packaging and transportation of telescoping members. In some cases, the bracket members 304, 308 can be substantially identical except for a limited number of features (e.g., surface indications, length of rail members, etc., as discussed below). Specifically, as illustrated in FIGS. 4 and 5, the first and second bracket rails 320a, 320b may be longer than the third and fourth bracket rails 324a, 324b, but the bracket members 304, 308 may be otherwise structurally substantially identical.

As described above, centerplate rail members can slidably nest with corresponding bracket rail members to provide telescopic adjustability to a support assembly. As illustrated in FIGS. 1-3, the first and second bracket member rails 320a, 320b may be inserted through a first end of the centerplate rails 216a, 216b. Furthermore, the third and fourth bracket member rails 324a, 324b may be inserted through a second end of the centerplate rails 216a, 216b, opposite the first end. As the centerplate rails 216a, 216b extend along opposite sides of the centerplate 200, and therefore opposite sides of the knockouts 204, the first and second bracket rails 220a, 220b received in the centerplate rails 216a, 216b may extend along opposite sides of the equipment 104 received in the opening 208 defined by the knockouts 204. Similarly, the third and fourth bracket rails 224a, 224b may extend along opposite sides of the equipment 104 received in the opening 208.

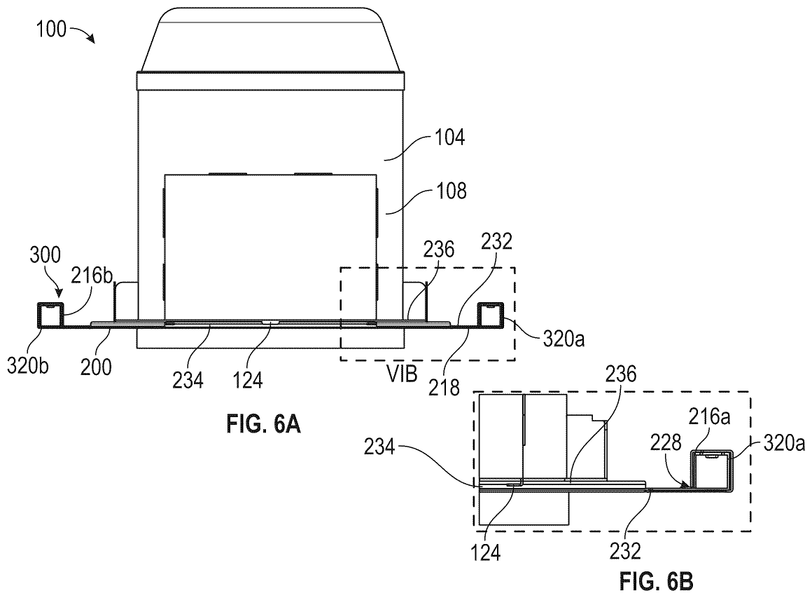

Generally, the rails 216a, 216b, 320a, 320b, 324a, 324b are sized to nest together with sufficient clearance for relative translational movement, to provide telescoping adjustability for the support assembly 100. As illustrated in FIGS. 6A and 6B, the rails 216a, 216b can accordingly have a larger cross-sectional profile than the rails 320a, 320b, 324a, 324b, so that the rail 216a can slidingly receive the rails 320a, 324a, and the rail 216b can slidingly receive the rails 320b, 324b. This arrangement allows the first and second bracket members 304, 308 to be slidably nested with the centerplate 200, providing the ability to telescopically adjust an extension of the support assembly 100 (e.g., measured in parallel to the extension axis 120) to span a range of distances between the first support structure 112 and the second building structure 116 (as shown in FIG. 7). The first and second bracket member rails 320a, 320b, and the third and fourth bracket member rails 324a, 324b may therefore be telescopically adjustable within the centerplate rails 216a, 216b, relative to the centerplate 200 and relative to each other. Slidably positioning the centerplate 200 relative to the first and second bracket members 304, 308 utilizing the described configuration can allow workers to install the support assembly 100 with an infinitely variable extension length, increasing installation flexibility of the support assembly 100. While the FIGS. shows a system with two sets of telescoping rails, some embodiments could vary in this regard, for example by having fewer (or more) than two sets of telescoping rails.

In some embodiments, a size and shape of the rails 216a, 216b, 320a, 320b, 324a, 324b may help to mitigate flex and other unwanted movement of the support assembly 100. Referring briefly to FIG. 1, each of the rails 216a, 216b, 320a, 320b, 324a, 324b may define an elongated tubular shape. More specifically, each of the rails 216a, 216b, 320a, 320b, 324a, 324b may be elongate along the extension direction, and, referring again to FIGS. 6A and 6B, may further include a cross-sectional shape having a solid perimeter and a hollow center.

In some examples, the perimeter of a relevant rail cross-section may not be fully continuous. For example, a formed rectangular or other tube for a rail may include a seam or other gap along vertex thereof or at other locations. In particular, such a configuration can beneficially contribute to overall strength and durability of brackets according to this disclosure. For example, as further discussed below, with reference to FIGS. 6A and 6B, a gap 228 at an inner bottom edge of the centerplate rail 320a allows the rail 320a to be formed as a relatively rigid tube, with close sliding engagement of the rail 216a, while still allowing clearance for material that extends from the support portion 218 of the centerplate 200 to connect to the integrally formed rail 216a.

Still referring to FIGS. 6A and 6B, each of the rails 216a, 216b, 320a, 320b, 324a, 324b may define the same cross-sectional shape (e.g., relative to a cross-section taken perpendicular to the extension direction). For example, as illustrated in FIGS. 6A and 6B, the rails 216a, 216b, 320a, 320b, 324a, 324b may each define a rectangular cross-sectional shape. Such an arrangement may be particularly beneficial as compared to conventional approaches, providing improved rigidity overall without loss of adjustability. However, in other examples, one or more of the rails 216a, 216b, 320a, 320b, 324a, 324b may define other cross-sectional shapes (e.g., square, triangular, circular, or other applicable shapes).

In some examples, the rails 216a, 216b, 320a, 320b, 324a, 324b may be sized to reduce movement of the rails 216a, 216b, 320a, 320b, 324a, 324b relative to one another in a direction that is perpendicular or oblique to the extension direction. For example, the rails 216a, 216b may define centerplate rail widths measured perpendicular to the extension direction and parallel to a front surface of the centerplate 200 that are about 0.2 inches greater than bracket member rail widths of the bracket rails 320a, 324a measured perpendicular to the extension direction and parallel to a front surface of the centerplate 200. In other examples, the centerplate rail widths may be less than about 0.2 inches (inclusive) greater than the bracket member rail widths, or less than about 0.3 inches (inclusive) greater than the bracket member rail widths. Furthermore, the rails 216a, 216b may define centerplate rail heights measured perpendicular to the extension direction and perpendicular to a front surface of the centerplate 200 that are about 0.1 inches greater than bracket member rail heights of the bracket rails 320a, 324a measured perpendicular to the extension direction and perpendicular to a front surface of the centerplate 200. In other examples, the centerplate rail heights may be less than about 0.1 inches (inclusive) greater than the bracket member rail heights, or less than about 0.2 inches (inclusive) greater than the bracket member rail heights. In some examples, the bracket rails 320b, 324b may define similar or identical dimensional relationships with the centerplate rail 216b. Utilizing the nested rails 216a, 216b, 320a, 320b, 324a, 324b that define height and width dimensions with small amounts of clearance can help to mitigate flexing or other unwanted movement of the support assembly 100.

In some examples, the bracket rails 320a, 324a may define the same bracket member width or the same bracket member height. Free ends of the bracket rails 320a, 324a may therefore engage one another (e.g., abut), without becoming nested within one another. As described further below, the bracket rails 320a, 324a may engage within the centerplate rails 316a at a minimum extension length of the support assembly, or may in some cases remain spaced apart along the extension direction at a minimum extension length. In some examples, the bracket rails 320b, 324b may also define the same bracket member width or the same bracket member height.

As illustrated in FIG. 5, one or more rail members may include a tab configured to provide mechanical resistance to telescopic movement or to block against telescopic over-adjustment of the support assembly. Such an arrangement, for example, may increase sliding resistance to prevent unwanted length changes adjustment during staging or installation, or block sliding movement to prevent unwanted separation of parts. Specifically, the centerplate rails 216a, 216b may include centerplate tabs 220 configured to contact the first, second, third, and fourth bracket member rails 320a, 320b, 324a, 324b slidably nested within the centerplate rails 216a, 216b. Additionally, one or more of the bracket member rails 320a, 320b, 324a, 324b may include bracket tabs 328 configured to contact the centerplate rails 216a, 216b. As also discussed below, in some examples, the centerplate tabs 220 and the bracket tabs 328 may engage one another to prevent over-extension of the support assembly 100.

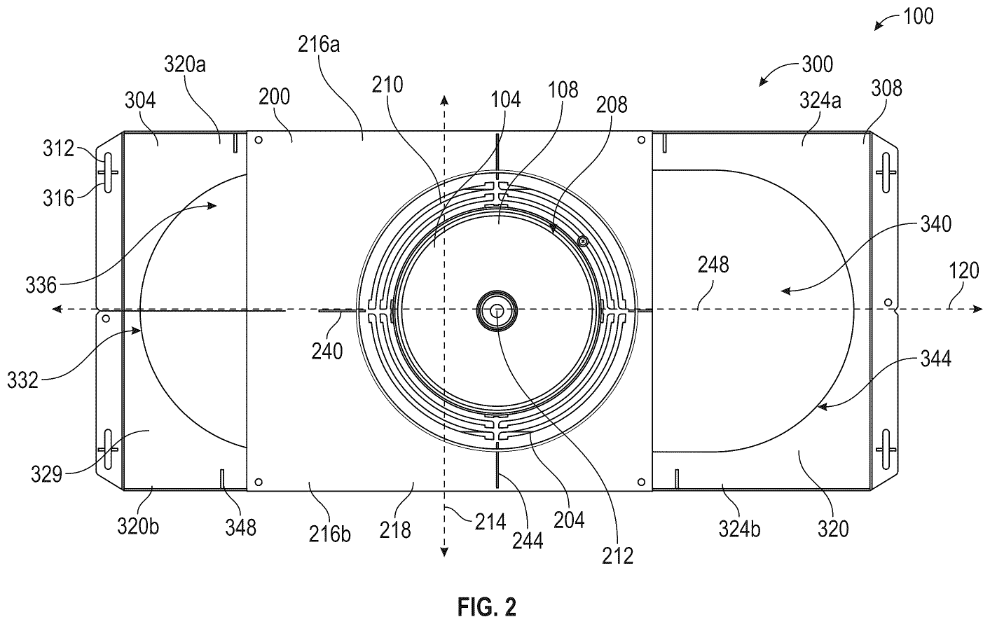

Referring again to FIGS. 1 and 2, in some embodiments, the centerplate 200 may include fastener apertures 224 configured to receive and retain fasteners (e.g., screws or other known fasteners, not shown) to couple the centerplate 200 to the bracket members 304, 308, and to fix a position of the centerplate 200 relative to the bracket members 304, 308. In some embodiments, a single fastener may be sufficient to fix a position of the centerplate 200 relative to the bracket members 304, 308 and the building structures.

In some examples, each of the first and second bracket members 304, 308 may include a wall that connects the rails of the first and second bracket members 304, 308, respectively. For example, a first wall 329 may extend between and couple the rails 320a, 320b of the first bracket member 304, and a second wall 330 may extend between and couple the rails 324a, 324b of the second bracket member 308. Furthermore, the first wall 329 may extend from the flange 312 of the first bracket member 304 and the second wall 330 may extend from the flange 312 of the second bracket member 308. In some examples, the first wall 329 and the second wall 330 may each extend integrally from the respective rails 320a, 320b, 324a, 324b, and the respective flanges 312. In some examples, the walls 329, 330 connecting the respective rails 320a, 320b, 324a, 324b may help to mitigate rotation or other unwanted movement of the rails 320a, 320b, 324a, 324b, ultimately aiding the stability of the support assembly 100. For example, the first wall 329 may help to mitigate rotation or other unwanted movement of the rail 320a relative to the rail 320b.

As described above, the first and second bracket members 304, 308 may each include a respective cutout. For example, the first bracket 304 member may include a first cutout 332, centered between the first bracket member rails 320a, 320b, extending along the first wall 329 from a first edge of the first bracket member 304 opposite the flange 312, toward the flange 312. The first cutout 332 may extend from the first edge toward a blind end 336. The blind end 336 may define a semi-circular shape having a diameter that is greater than or equal to a diameter of the largest of the plurality of knockouts 204 (or the rings 210). A width of the first cutout 332 between the first edge and the blind end 336, measured substantially perpendicular to the first bracket member rails 320a, 320b, may be greater than or equal to a diameter of the largest of the plurality of knockouts 204. As illustrated in FIG. 3 the first cutout 332 may allow the first bracket member 304 to be slidably adjusted relative to the centerplate 200 without interfering with the knockouts 204, or with the equipment 104 secured to the knockouts 204. In some embodiments, the second bracket 308 member may include a second cutout 340 (e.g., substantially similar to the first cutout 332, except relative to length). The second cutout 340 may extend along the second wall 330 from a second edge of the second bracket 308 to a second blind end 344, to ease slidable adjustment of the second bracket member 308 relative to the centerplate 200.

As illustrated in FIGS. 10-11B and described further below, in some examples, an edge of the centerplate 200 may contact the flange 312 of the second bracket member 308, to position the knockouts 204 at the second blind end 344 nearest one of the building structures 112, 116. As illustrated by the present example, the second blind end 344 may be shaped to ensure that the second bracket member 308 does not interfere with the knockouts 204 or the lighting assembly 108 received by the knockouts 204.

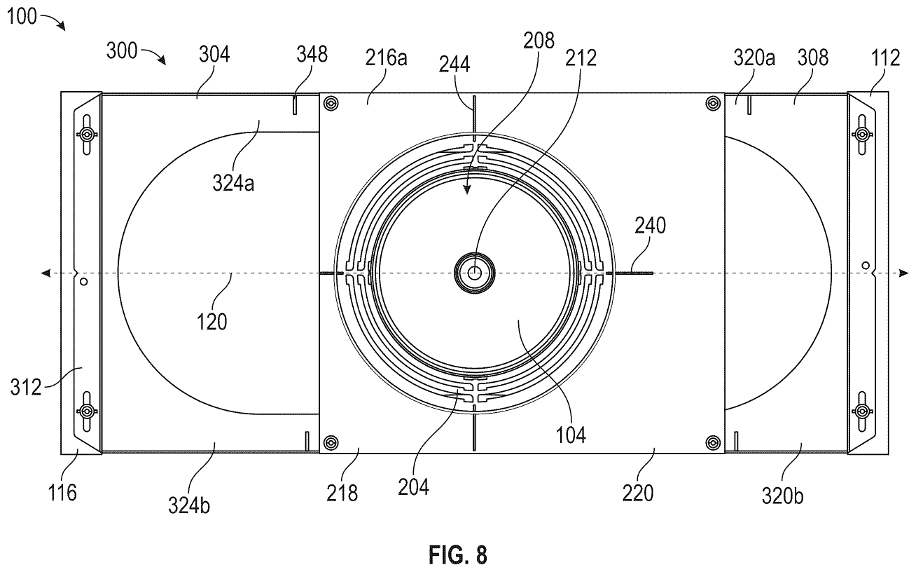

Referring again to FIGS. 1 and 2, in some embodiments, the bracket members 304, 308 may include markings 348 (e.g., ruler marking). In some examples, the markings 348 may indicate an extension length of the support assembly 100 (e.g., 25 ½″, 24″, 22.5″, or some other relevant extension length). Specifically, the extension length may be measured substantially parallel to the extension axis 120 between a center of each of the first and second building structures 112, 116 (see FIG. 8). In some embodiments, aligning the centerplate 200 on one or more of the markings 348 may provide an indication of the extension length of the support assembly 100. Additionally, in some embodiments, aligning the centerplate 200 on one or more of the markings 348 may provide an indication that the center point 212 of the knockouts is centered relative to a center of the support assembly 100. Although the markings 348 may indicate an extension length of the support assembly 100, installers may not utilize the markings 348, as desired. For example, as generally discussed above, installers may instead extend the support assembly 100 to any relevant extension length, and position the centerplate 200 at any relevant position relative to the bracket members 304, 308.

Referring to FIGS. 6A and 6B, as described above, the plurality of centerplate rail members can slidably nest with the first and second plurality of bracket rail members. As illustrated and also noted above, the first and second centerplate rails 216a, 216b may each define a gap 228 between an edge of the first and second centerplate rails 216a, 216b and a rear face 232 of the centerplate 200. For example, the gap 228 may be in the perimeter shape of each of the rails 216a, 216b. The gap 228 may allow the first and second bracket members 304, 308 to extend unimpeded from the bracket member rails 320a, 320b, 324a, 324b toward the plurality of knockouts 204, aiding the movability of the first and second bracket members 304, 308 relative to the centerplate 200.

Still referring to FIGS. 6A and 6B, in some embodiments, a perimeter of the plurality of knockouts 204 may protrude from a larger body of the centerplate 200 (e.g., with an extrusion 234, as shown). Correspondingly, a rear knockout face 236 may be offset relative to the rear face 232 of the centerplate 200 (e.g., relative to the support portion 218 of the centerplate 200). As illustrated in FIGS. 6A and 6B, the offset created by the extrusion 234 between the rear knockout face 236 and the rear face 232 of the centerplate 200 may accommodate projections 124 extending from the equipment 104 (e.g., projections extending from an electrical box of the lighting assembly 108 mounted to the centerplate 200). For example, the extrusion 234 of the centerplate 200 may ensure the projections 124 do not contact the rear face 232 of the centerplate 200, easing installation and adjustability. Additionally, the extrusion 234 may reinforce the centerplate 200 by providing extra rigidity to mitigate flexion or bending of the centerplate 200 and the support assembly 100.

In some embodiments, the centerplate 200 is movable along the bracket rails 320a, 320b, 324a, 324b and relative to building structures, to a desired extension length or configuration. Referring again to FIG. 2, in some embodiments, the centerplate 200 can include alignment indentations that can aid the installation and the alignment of the support assembly 100. For example, the centerplate 200 may include a first set of alignment indentations 240 and a second set of alignment indentation 244. Each of the first and second sets of alignment indentations 240, 244 may include one or more linear indentations that can be stamped into the centerplate 200. Furthermore, each of the linear indentations of the first set of alignment indentations 240 can be aligned with one another (e.g., linearly), and each of the linear indentations of the second set of alignment indentations 244 can be aligned with one another (e.g., linearly). As described below, the first and second sets of alignment indentations 240, 244 may aid the visualization of the center point 212 of the knockouts 204 for the installers.

In some examples, the first set of alignment indentations 240 may extend parallel to the extension axis 120 along a second centerline 248 of the centerplate 200, providing a visual representation of the second centerline 248 for installers. Furthermore, the second set of alignment indentations 244 may extend substantially perpendicular to the first set of alignment indentations 240 (e.g., perpendicular to the extension axis 120). In some examples, the second set of alignment indentations 244 may extend parallel to and be offset from the first centerline 214. The second set of alignment indentations 244 may aid the visualization of the center point 212 of the knockouts 204. In such examples, a first line drawn between the first set of alignment indentations 240 and a second set line drawn between the second set of alignment indentations 244 may intersect at the center point 212 of the knockouts 204.

During installation, the installers may use laser alignment devices, or other applicable alignment devices, to align the centerplate 200 relative to the building structures, relative to a layout of a room, or relative to other centerplates. For example, the installers may slidably move the centerplate 200 along the bracket rails 320a, 320b, 324a, 324b to properly align the centerplate 200 and the equipment 104 along the support assembly 100. The first and second sets of alignment indentations 240, 244 may advantageously aid the alignment process of the centerplate 200, by providing installers a readily visible marking on the centerplate 200 for visualizing alignment of the centerplate 200.

FIGS. 7-9B illustrate the support assembly 100 secured between the first and second building structures 112, 116 in a first configuration (or orientation). More specifically, the bracket rails 320a, 320b, 324a, 324b can be slidably movable or adjustable relative to the centerplate 200 to the first configuration. In the first configuration, the centerplate 200 can be aligned with markings 348 that indicate the extension of the support assembly 100 is 24.5 inches and that the center point 212 of the plurality of knockouts 204 is centered relative to the support assembly 100. In some examples, the first configuration can correspond to a maximum installed spacing between the first and second building structures 112, 116.

In some embodiments, the bracket rails 320a, 320b of the first bracket member 304 may not overlap with the bracket rails 324a, 324b of the second bracket member 308. For example, in the first configuration, free ends of the bracket rails 320a, 320b, of the first bracket member 304 (e.g., ends of the rails 320a, 320b disposed within the rails 216a, 216, respectively) may be spaced from free ends of the bracket rails 324a, 324b of the second bracket member 308 (e.g., ends of the bracket rails 324a, 324b disposed within the rails 216a, 216b, respectively). More specifically, a first gap 352 that extends parallel to the extension axis 120 may separate the free end of the rail 320a from the free end of the rail 324a within the rail 216a and a second gap 356 that extends parallel to the extension axis 120 may separate the free end of the rail 320b from the free end of the rail 324b within the rail 216b.

In some embodiments, the first bracket member 304 and the second bracket member 308 can be asymmetrical relative to the first centerline 214. For example, in the first configuration, the bracket rails 320a, 320b can each extend a first distance into the first and second centerplate rails 216a, 216b, respectively, parallel to the extension axis 120. Similarly, the bracket rails 324a, 324b can each extend a second distance into the first and second centerplate rails 216a, 216b, respectively, parallel to the extension axis 120. More specifically, the second distance can be larger than the first distance, such that the bracket rails 320a, 320b extend farther into the centerplate rails 216a, 216b than the bracket rails 324a, 324b. Consequently, a first length of the first bracket rail 320a nested in the first centerplate rail 316a can be longer than a second length of the second bracket rail 324a nested in the first centerplate rail 316a. Furthermore, the first bracket member 304 and the second bracket member 308 can be asymmetrically positioned relative to the centerplate 200.

In some embodiments, the one or more of the bracket rails 320a, 320b, 324a, 324b may extend into the centerplate rails 216a, 216b and across the first centerline 214 of the centerplate 200. For example, in the first configuration, the bracket rails 320a, 320b may extend into the centerplate rails 216a, 216b and across the first centerline 214 of the centerplate 200.

In some embodiments, a distance between the first flange 312 of the first bracket member 304 and the centerplate 200 may be larger than a distance between the second flange 312 of the of the second bracket member 308 and the centerplate 200. As such, a length of the bracket rails 320a, 320b of the first bracket member 304 positioned exterior to the centerplate rails 216a, 216b may be greater than a length of the bracket rails 324a, 324b of second first bracket member 304 positioned exterior to the centerplate rails 216a, 216b.

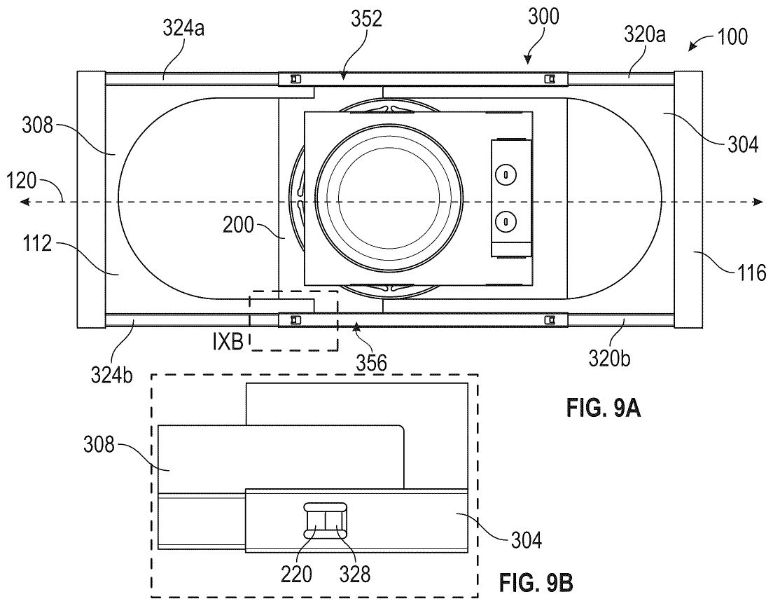

In the first configuration the second bracket member 308 may be positioned at a maximum extension length. As illustrated in FIGS. 9A and 9B, the bracket tab 328 of the second bracket member 308 may engage the centerplate tab 220 to mitigate further extension of the second bracket member 308 relative to the centerplate 200 (i.e., to secure the bracket 300 from extending beyond a maximum installation length).

FIGS. 10-11B illustrate the support assembly 100 secured between the first and second building structures 112, 116 in a second configuration. More specifically, the bracket rails 320a, 320b, 324a, 324b can be slidably movable relative to the centerplate 200 to the second configuration (e.g., from the first configuration or another configuration). In the second configuration the first bracket member 304 may be positioned at a maximum extension length relative to the first centerline 214, and an extension length of the support assembly may be about 24.5 inches (e.g., a distance between centers of the building structures 112, 116). As illustrated in FIGS. 11A and 11B, the bracket tab 328 of the second bracket member 308 may engage the centerplate tab 220 to mitigate further extension of the second bracket member 308 relative to the centerplate 200.

Similar to above, in the second configuration, the bracket rails 320a, 320b of the first bracket member 304 and the bracket rails 324a, 324b of the second bracket member 308 may not overlap. More specifically, a first gap 352 may separate the free end of the rail 320a from the free end of the rail 324a within the rail 216a and the second gap 356 may separate the free end of the rail 320b from the free end of the rail 324b within the rail 216b. Furthermore, in the second configuration, bracket rails 324a, 324b may extend into the centerplate rails 216a, 216b and across the first centerline 214 of the centerplate 200. As such, the bracket rails 324a, 324b of the second bracket member 308 may extend farther into the centerplate rails 216a, 216b than the bracket rails 320a, 320b of the first bracket member 304.

Still referring to FIGS. 10-11B, in the second configuration, the center point 212 of the knockouts 204 may be disposed at a closest position to the building structure 112. In the present example, the knockouts 204 may be received by the second blind end 344. Specifically, the extrusion 234 of the knockouts 204 may contact the second blind end 344. As illustrated in FIG. 10, the asymmetrical centerplate 200 includes the center point 212, which is offset on the centerplate 200 in a direction that is towards the building structure 112. The offset orientation of the center point 212 may therefore allow the plurality of knockouts 204 to be positioned closer to the building structure 112 than in conventional approaches. For example, the offset of the center point 212 may permit a center of the equipment 104 extending through the knockouts 204 to be positioned less than 5 inches from an edge of the building structure 112, closer than the support assemblies 100, 400, discussed above.

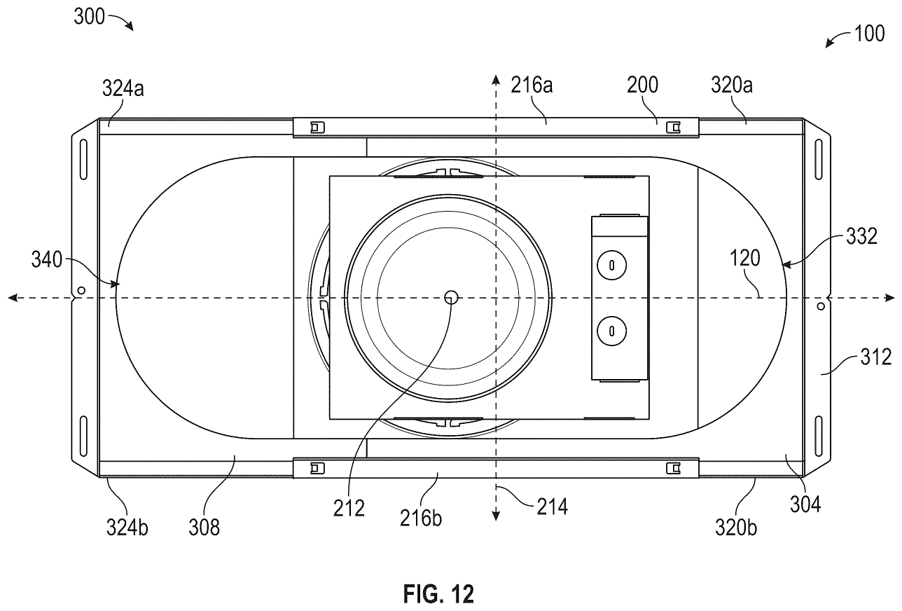

FIG. 12 illustrates the support assembly 100 in a third configuration. In the third configuration the support assembly 100 may be positioned at a minimum extension length (e.g., about 22.5 inches—a common distance between a center of two studs in ceiling assemblies). As illustrated in FIG. 12, in the third configuration, the first and second bracket members 304, 308 may contact each other (e.g., at the free ends of corresponding rails). Furthermore, the first and second bracket members 304, 308 may not nest within one another. The first and second bracket members 304, 308 may therefore not be translated any further toward one another, as the free ends of the bracket rails 320a, 320b of the first bracket 304 provide a contact stop for the bracket rails 324a, 324b of the second bracket 308. In some configurations, to create a support assembly with a shorter minimum extension length, workers in the field may be able to cut or otherwise reduce a length of one or more of the rails 320a, 320b, 324a, 324b.

As illustrated in the illustrated configurations of FIGS. 7-12, the adjustable bracket may be asymmetrical overall, relative to the first centerline 214 of the centerplate 200. As discussed above, the rails 320a, 320b may be longer than the rails 324a, 324b causing asymmetrical extension distances of the respective first and second bracket members 304, 308 relative to the first centerline 214. In some examples, the differing lengths of the rails 320a, 320b relative to the rails 324a, 324b may account for the asymmetry of the centerplate 200. Furthermore, the differing lengths of the rails 320a, 320b relative to the rails 324a, 324b may aid the positioning of the support assembly 100 in the second configuration. Specifically, at a maximum extension of the rails 320a, 320b, which are longer than the rails 324a, 324b, may permit an extension length of the support assembly 100 to be 25.5 inches (e.g., a common distance between a center of two studs in a hard lid ceiling), while still allowing the center point 212 of the knockouts 204 to be positioned less than 5 inches from the edge of the building structure 112.

Though only three specific configurations are described in detail, as disclosed above, installers may extend the support assembly 100 to any relevant extension length along a range of lengths. Further, at a given extension length, installers may also generally adjust the centerplate 200 to any relevant position relative to the bracket members 304, 308, along a range of positions (corresponding to the particular extension length).

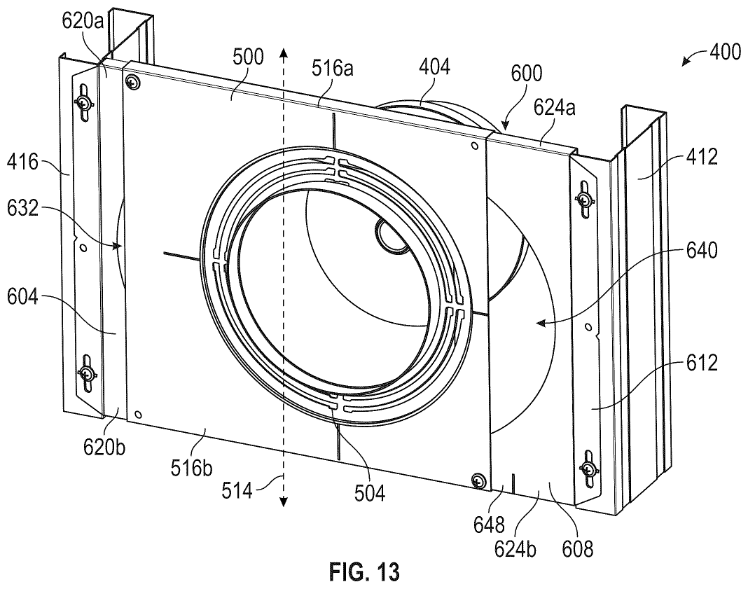

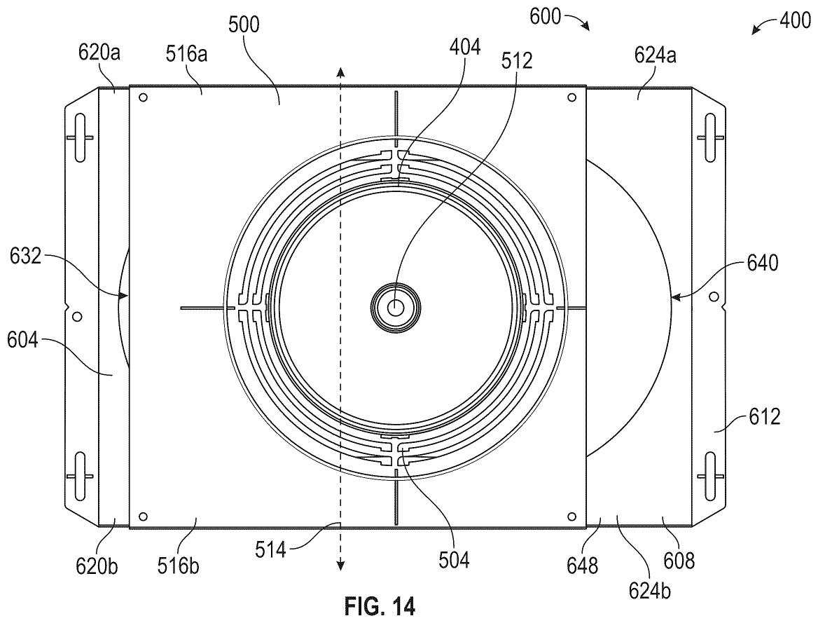

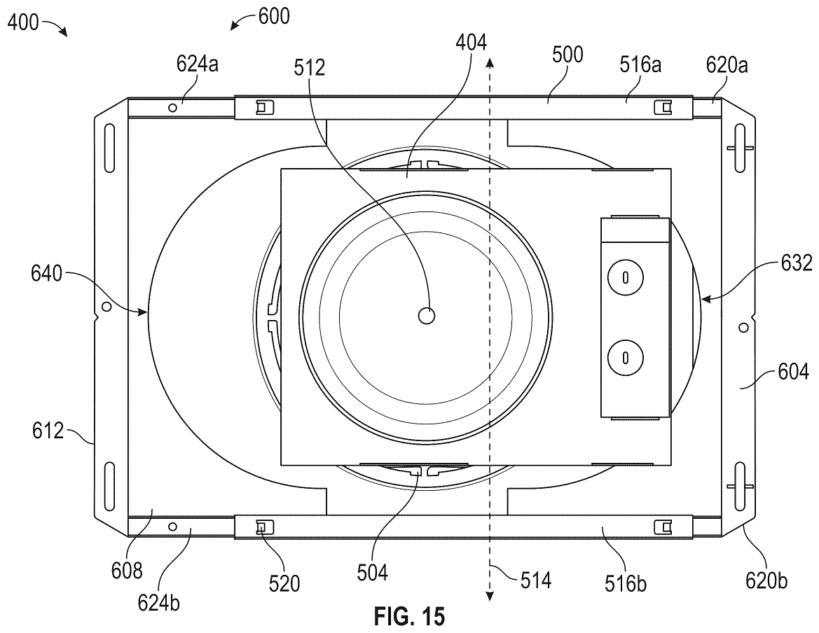

In some embodiments, adjustable support assemblies may be configured to support equipment between building structures that are positioned a shorter distance apart than illustrated in FIGS. 9-12. In this regard, for example, FIGS. 13-21 illustrate another embodiment of a support assembly 400. The support assembly 400 of FIGS. 13-21 may generally include similar features as the support assembly 100 of FIGS. 1-12 including but not limited to a centerplate 500 having a plurality of knockouts 504 disposed concentrically around a center point 512 (e.g., offset from a centerline 514), rails 516a, 516b and centerplate tabs 520, an adjustable bracket 600 including first and second bracket members 604, 608 having rails 620a, 620b and rails 624a, 624b, respectively, a first cutout 632 and a second cutout 640, respectively, flanges 612, bracket tabs 628, and markings 648. Thus, discussion of support assembly 100 above also generally applies to similarly numbered or named components of the support assembly 400 (and vice versa).

Similar to the support assembly 100, the support assembly 400 may define an extension length. The extension length of the support assembly 400 may be varied between about 14.5 inches and about 17.5 inches.

FIGS. 13-15 illustrate the support assembly 400 secured between a first and second building structures 412, 416 in a fourth configuration. Specifically, the centerplate 500 is aligned with the markings 648 that indicate the extension of the support assembly 400 is 16 inches and that the center point 512 of the plurality of knockouts 504 is centered relative to the support assembly 400.

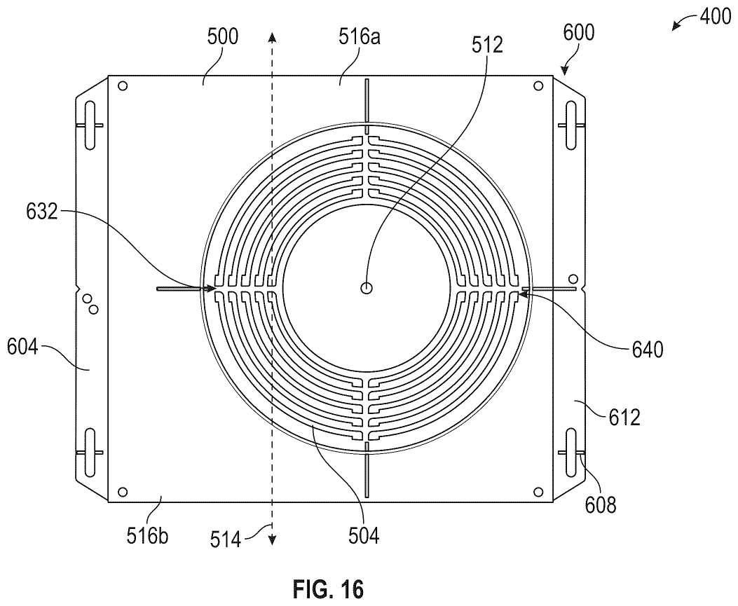

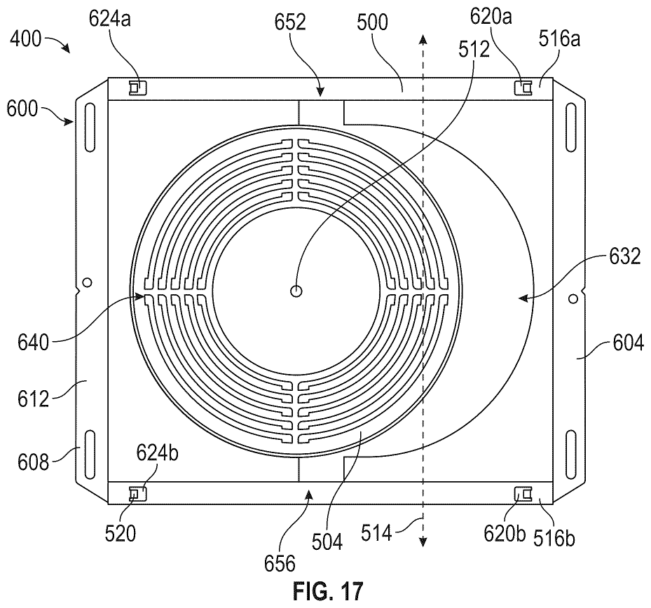

FIGS. 16 and 17 illustrate the support assembly 400 in a fifth configuration. In the fifth configuration the support assembly 400 may be positioned at a minimum extension length (e.g., about 11.4 inches). As illustrated in FIGS. 16 and 17, in the fifth configuration, the flanges 612 of the first and second bracket members 604, 608 may contact the centerplate 500. The first and second bracket members 304, 308 may therefore not be translated any further toward one another.

Similar to above, in the fifth configuration, the bracket rails 620a, 620b of the first bracket member 604 and the bracket rails 624a, 624b of the second bracket member 608 may not overlap. More specifically, a first gap 652 may separate the free end of the rail 620a from the free end of the rail 624a within the rail 516a and the second gap 656 may separate the free end of the rail 620b from the free end of the rail 624b within the rail 516b.

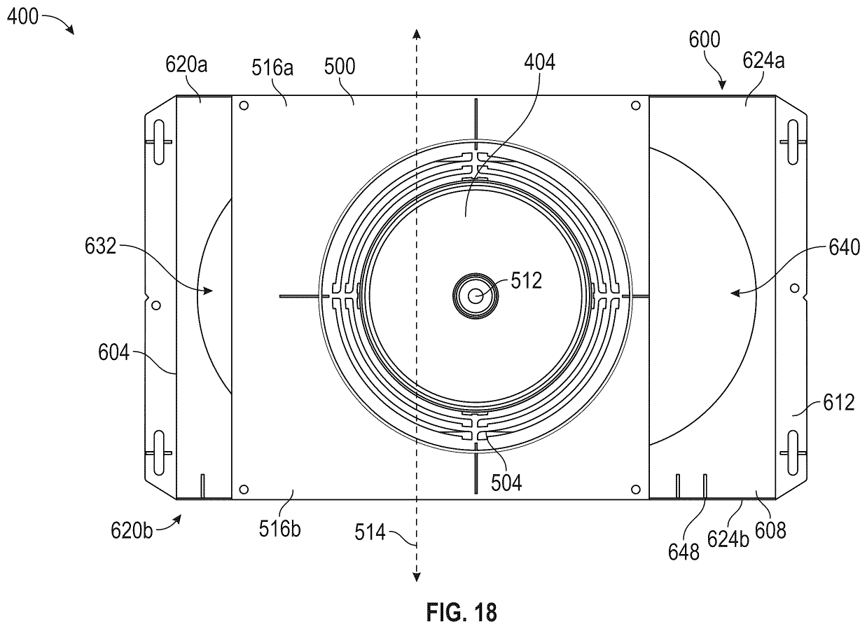

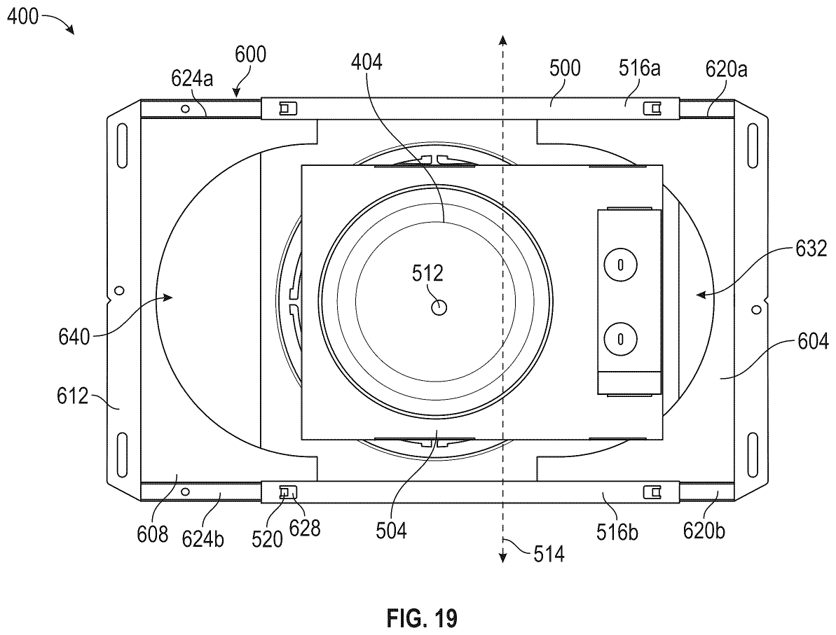

FIGS. 18 and 19 illustrate the support assembly 400 in a sixth configuration. Specifically, the centerplate 500 is aligned with the markings 648 that indicate the extension of the support assembly 400 is 17.5 inches and that the center point 512 of the plurality of knockouts 504 is centered relative to the support assembly 400. Furthermore, FIG. 19 illustrates the centerplate tabs 520 engaging with the bracket tabs 628 of the second bracket member 608 to prevent over-extension of the second bracket member 608.

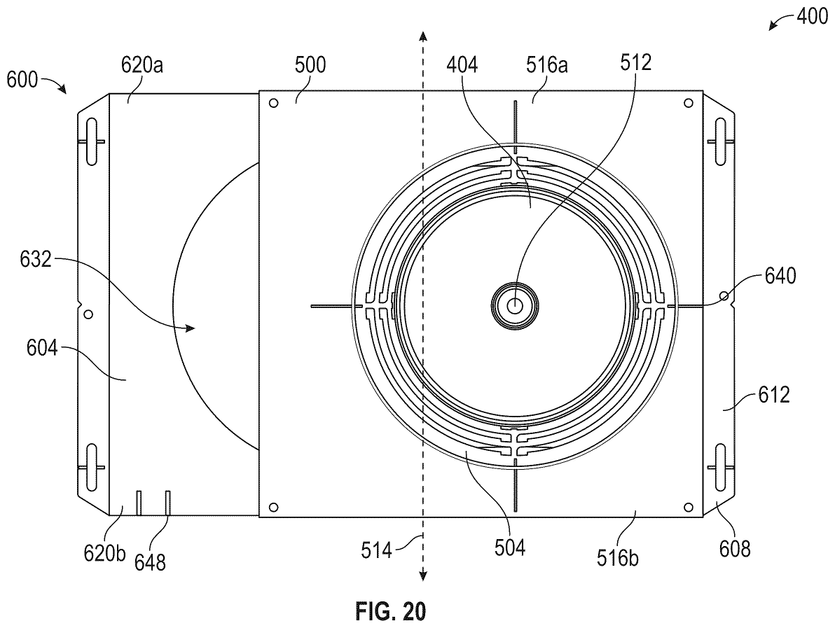

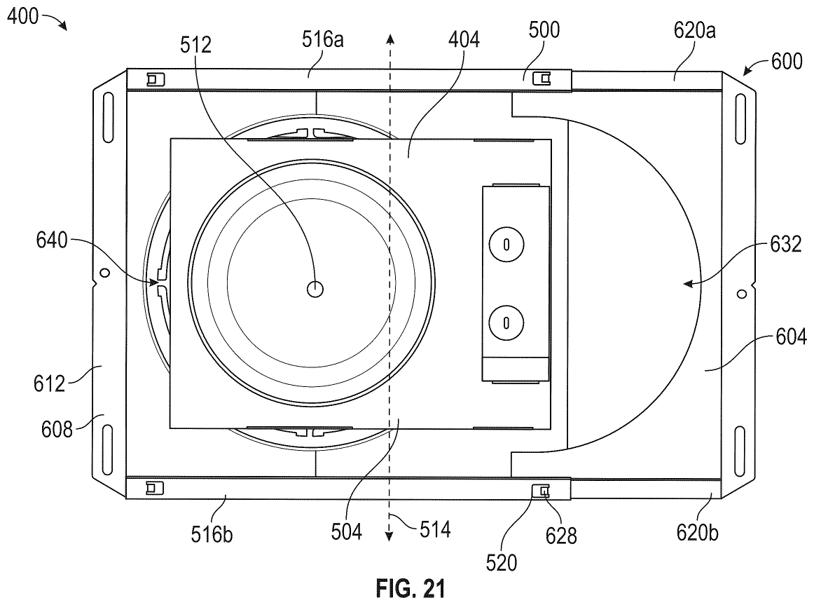

FIGS. 20 and 21 illustrate the support assembly 400 in a seventh configuration with an offset of the supported device toward the relevant ceiling member. Similar to the second configuration described above in the relation to the support assembly 100, in the seventh configuration the center point 512 of the knockouts 504 may be disposed at a closest position to the building structure 412. As illustrated in FIGS. 20 and 21, the asymmetrical centerplate 500 includes the offset center point 512, that is offset in a direction that is towards the building structure 412. The offset center point 512 may therefore position the plurality of knockouts 504 closer to the building structure 412. The offset of the center point 512 may permit a center of the equipment 404 extending through the knockouts 504 to be positioned less than 5 inches from an edge of the building structure 412, closer than the existing support brackets discussed above.

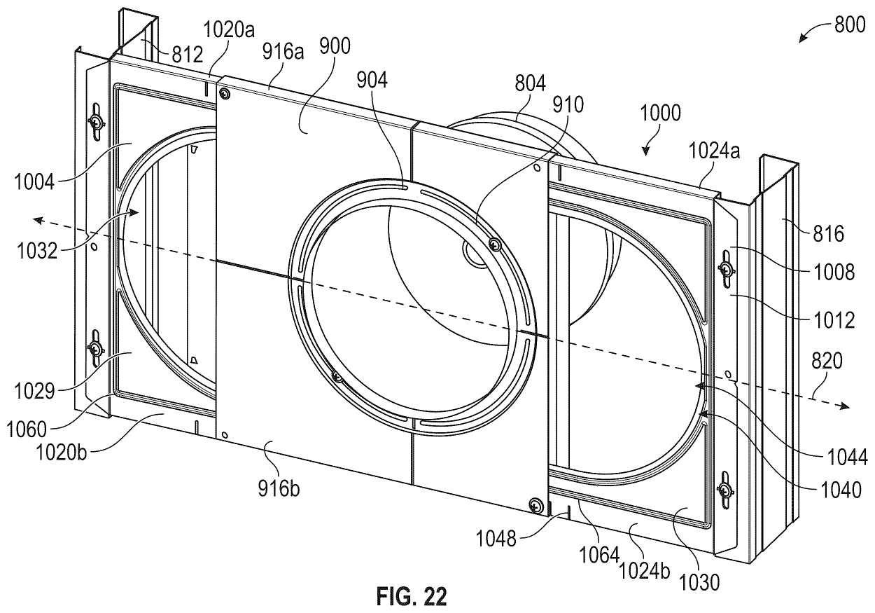

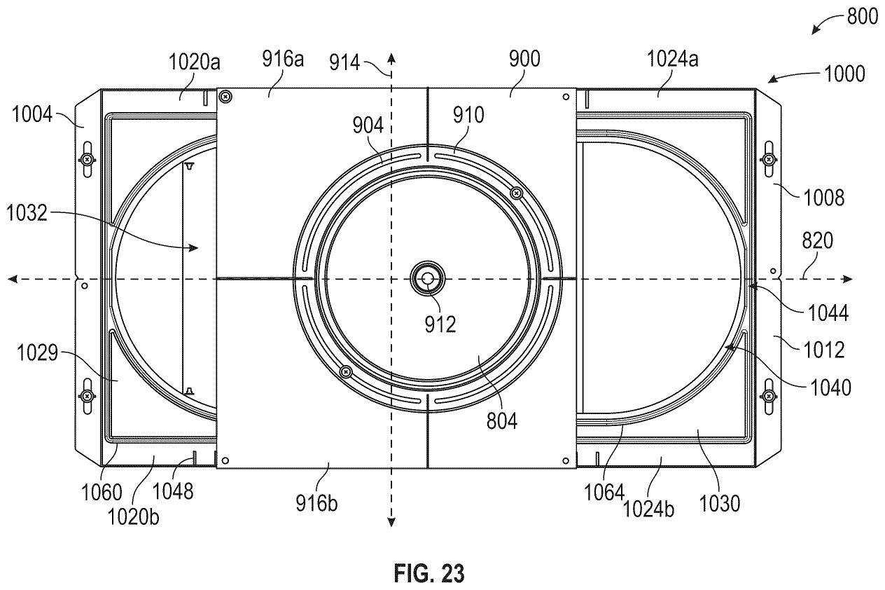

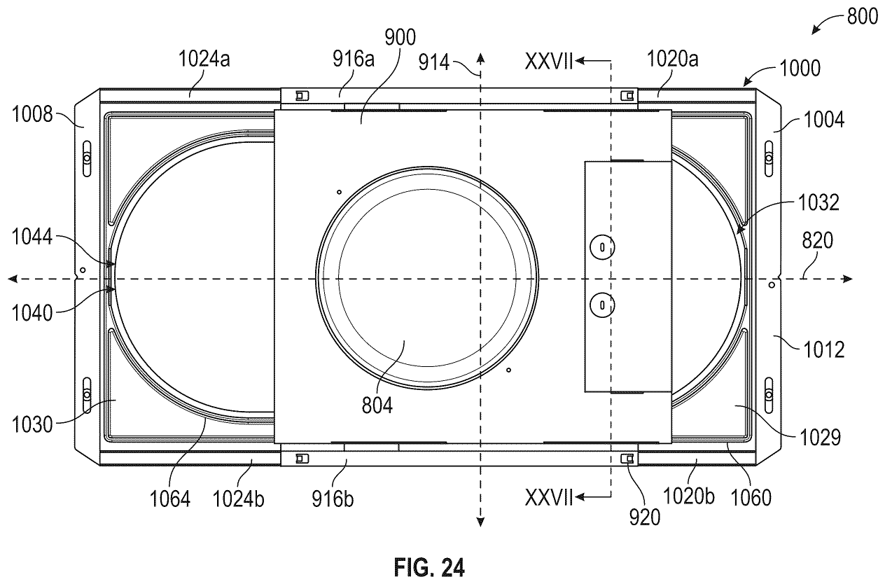

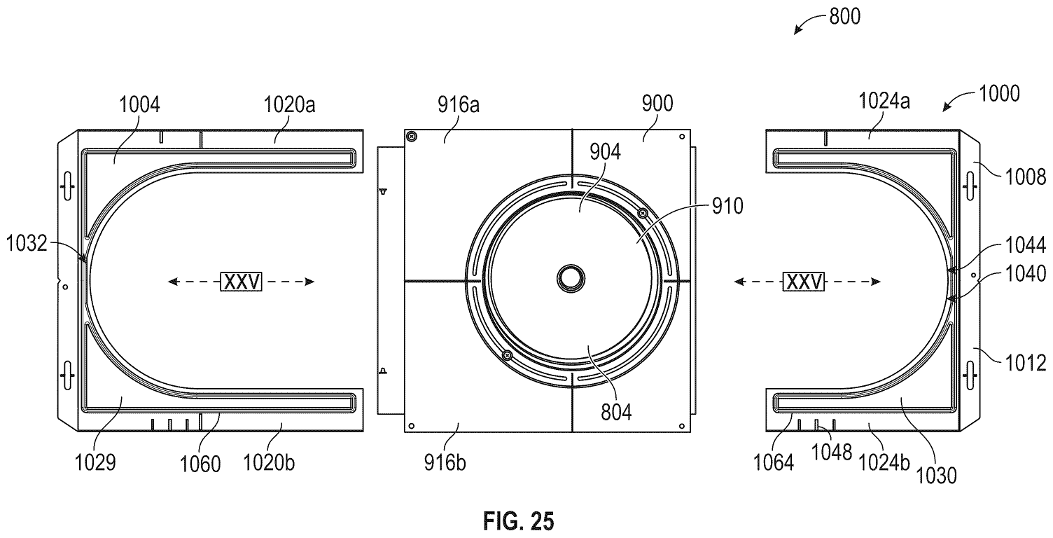

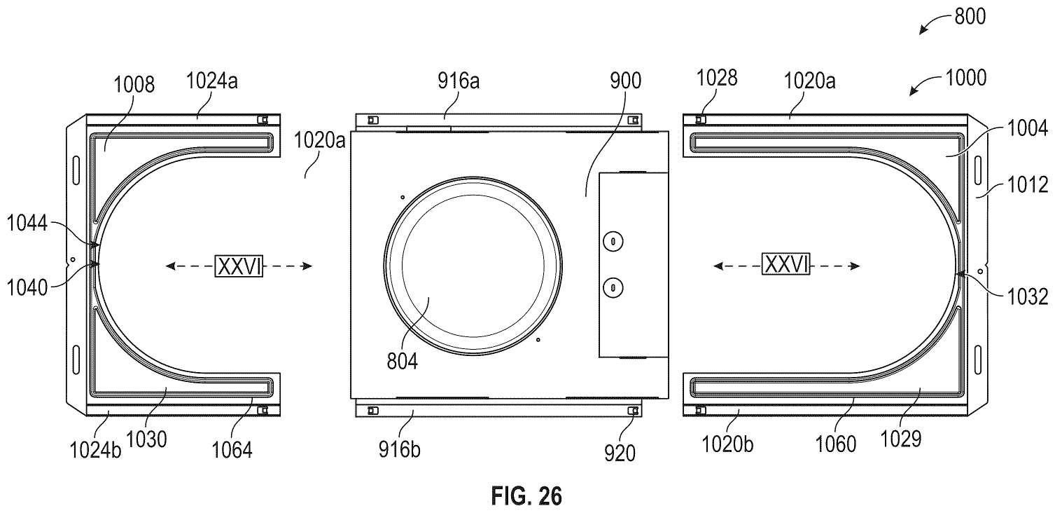

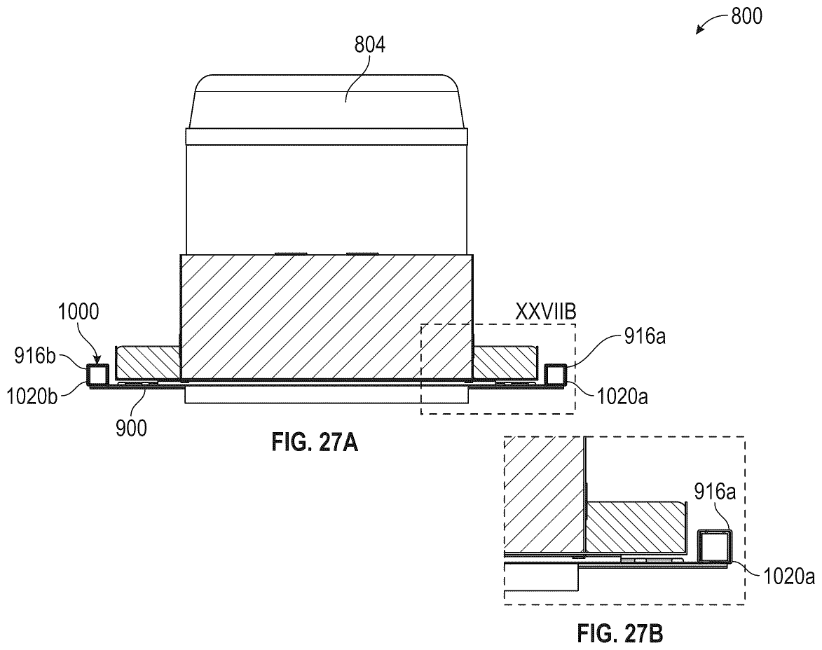

In some embodiments, adjustable support assemblies may be configured to support equipment between building structures that are positioned a farther distance apart than illustrated in FIGS. 1-21. In this regard, for example, FIGS. 22-33 illustrate another embodiment of a support assembly 800. The support assembly 800 of FIGS. 22-33 may generally include similar features as the support assembly 100 of FIGS. 1-12 and the support assembly 400 of FIGS. 13-21, including but not limited to an extension axis 820, a centerplate 900 having a plurality of knockouts 904 (e.g., rings 910) disposed concentrically around a center point 912 (e.g., offset from a centerline 914), rails 916a, 916b and centerplate tabs 920, an adjustable bracket 1000 including first and second bracket members 1004, 1008 having rails 1020a, 1020b and rails 1024a, 1024b, respectively, a first wall 1029 and a second wall 1030, a first cutout 1032 and a second cutout 1040, respectively, flanges 1012, bracket tabs 1028, and markings 1048. Thus, discussion of support assemblies 100, 400 above also generally applies to similarly numbered or named components of the support assembly 800 (and vice versa).

Similar to the support assemblies 100, 400, the support assembly 800 may define an extension length. The extension length of the support assembly 800 may be varied between about 31.5 inches and about 21.5 inches.

In some embodiments, the support assembly 800 may differ from the support assemblies 100, 400. For example, the knockouts 904 may include more of the rings 910 than the knockouts 204, 504. As such, a maximum diameter of the knockouts 904 may be larger than the maximum diameter of the knockouts 204, 504. Furthermore, due to the maximum diameter of the knockouts 904 being larger, a size of the cutouts 1032, 1040 of the first and second bracket members 1004, 1008, respectively, may be larger than the cutouts 332, 340, 632, 640, to accommodate larger the knockouts 904. Furthermore, due to the maximum diameter of the knockouts 904 being larger, a minimum possible distance between the center point 912 of the knockouts 904 and one of the building structures 812, 816 may be larger than a minimum possible distance between the center points 212, 512 of the knockouts 204, 504 and one the building structures.

Referring to FIGS. 22-26, in some examples, the first and second bracket members 1004, 1008 may include embossments, ridges, or extrusions, which may increase stability and rigidity of the support assembly 800. For example, the first and second bracket members 1004, 1008 may include an embossment on the first wall 1029 and the second wall 1030, respectively. In some examples, the embossments extending along the first wall 1029 and the second wall 1030 may define protrusions or indentations that extend rearward from the first wall 1029 and the second wall 1030. More specifically, in an installed configuration of the support assembly 800, the protrusions or indentations defined by the embossments extend away from the centerplate 900 to mitigate interference during adjustment of the support assembly 800. However, in other configurations, the protrusions defined by the embossments may instead extend toward the centerplate 900.

In some examples, a first embossment 1060 on the first wall 1029 may extend around a perimeter of the first wall 1029 or around a perimeter of the first cutout 1032. More specifically, the first embossment 1060 may extend along a connection between the first wall 1029 and the bracket rails 1020a, 1020b along a connection between the first wall 1029 and the flange 1012 of the first bracket member 1004, and around the first cutout 1032. In some examples, a second embossment 1064 on the second wall 1030 may extend around a perimeter of the second wall 1030 or around a perimeter of the second cutout 1040. More specifically, the second embossment 1064 may extend along a connection between the second wall 1030 and the bracket rails 1024a, 1024b, along a connection between the second wall 1030 and the flange 1012 of the second bracket member 1008, and around the second cutout 1040. However, in other examples, the first and second embossments 1060, 1064 may otherwise be shaped or may otherwise extend along the first and second bracket members 1004, 1008.

In some examples, equipment 804 may be secured to the centerplate 900 using one or more fasteners. For example, each of the plurality of rings 910 may be spaced apart from one another by one or more gaps. In some examples, one or more of the rings 910 may not be removable from the centerplate 900. Consequently, one or more of the gaps may be permanently available to receive the fasteners for securing the equipment 804 and to the centerplate 900.

FIGS. 22-26 illustrate the support assembly 800 secured between the first and second building structures 812, 816 in an eighth configuration. Specifically, the centerplate 900 is aligned with the markings 1048 that indicate the extension of the support assembly 800 is 25.5 inches and that the center point 912 of the plurality of knockouts 904 is centered relative to the support assembly 800. Similar to the first configuration of the support assembly 100, the free ends of the bracket rails 1020a, 1020b, of the first bracket member 1004 may be spaced parallel to the extension axis 820 from the free ends of the bracket rails 1024a, 1024b of the second bracket member 1008.

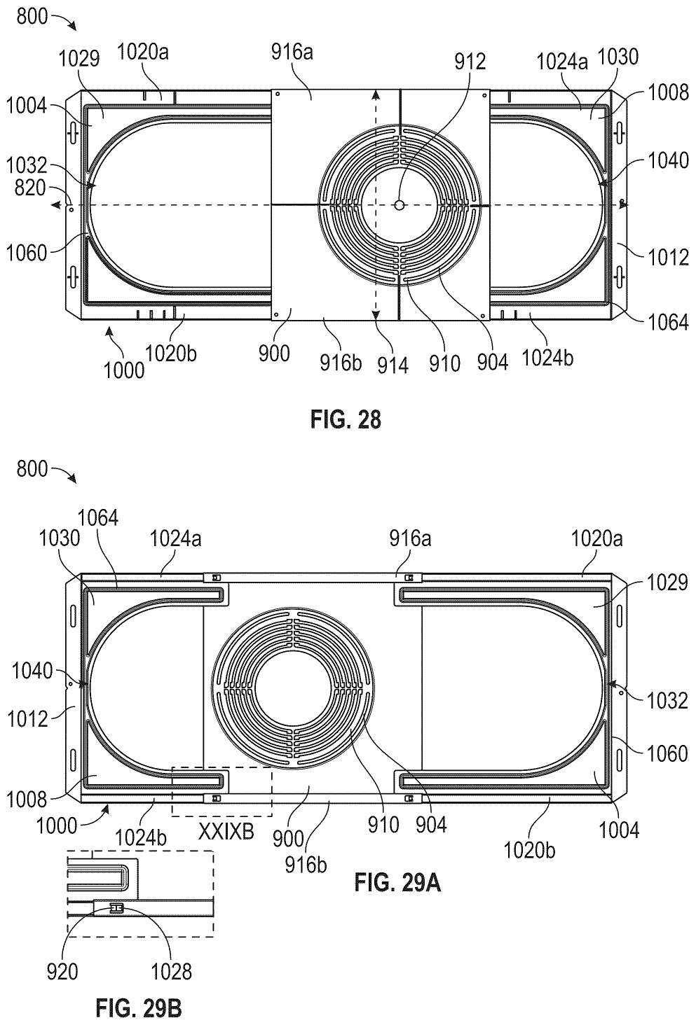

FIGS. 28-29B illustrate the support assembly 800 in a ninth configuration. In the ninth configuration the support assembly 400 may be positioned at a maximum extension length. As illustrated in FIGS. 28-29B, in the ninth configuration, the bracket tabs 1028 of the bracket rails 1020a, 1020b, 1024a, 1024b may engage the centerplate tabs 920. The first and second bracket members 1004, 1008 may therefore not be translated any further away from one another.

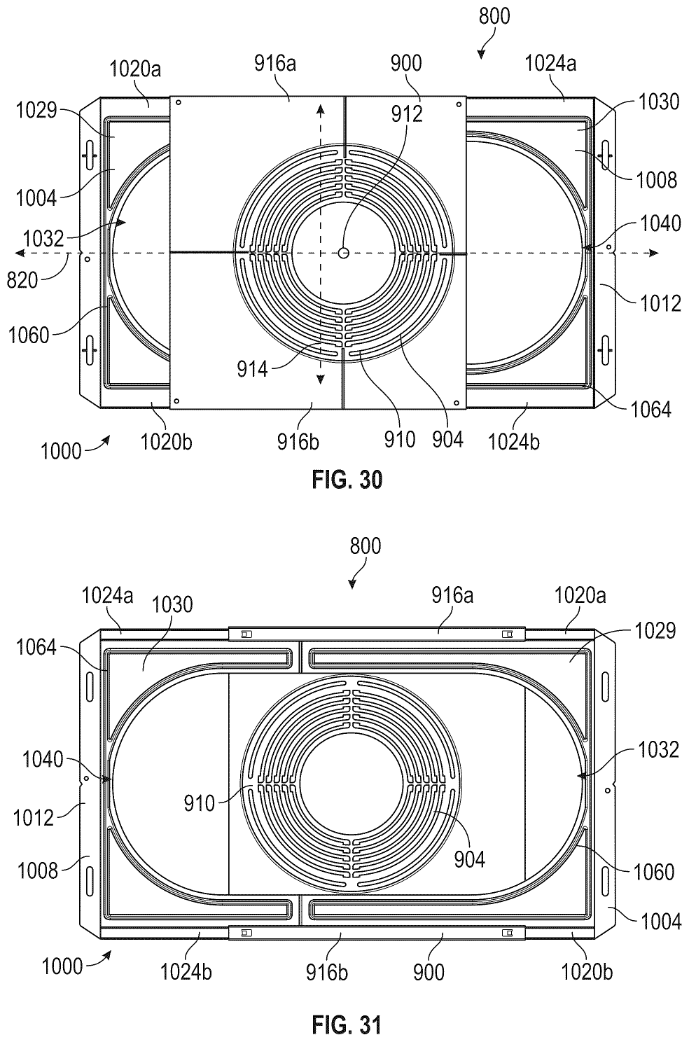

FIGS. 30 and 31 illustrate the support assembly 800 in a tenth configuration. Specifically, in the tenth configuration, the support assembly 800 may be positioned at a minimum extension length. As illustrated in FIG. 31, in the tenth configuration, the first and second bracket members 1004, 1008 may contact each other (e.g., at the free ends of corresponding bracket rails 1020a, 1020b, 1024a, 1024b). The first and second bracket members 1004, 1008 may therefore not be translated any further toward one another, as the free ends of the bracket rails 1020a, 1020b of the first bracket 1004 provide a contact stop for the bracket rails 1024a, 1024b of the second bracket 1008. In some configurations, to create a support assembly with a shorter minimum extension length, workers in the field may be able to cut or otherwise reduce a length of one or more of the bracket rails 1020a, 1020b, 1024a, 1024b.

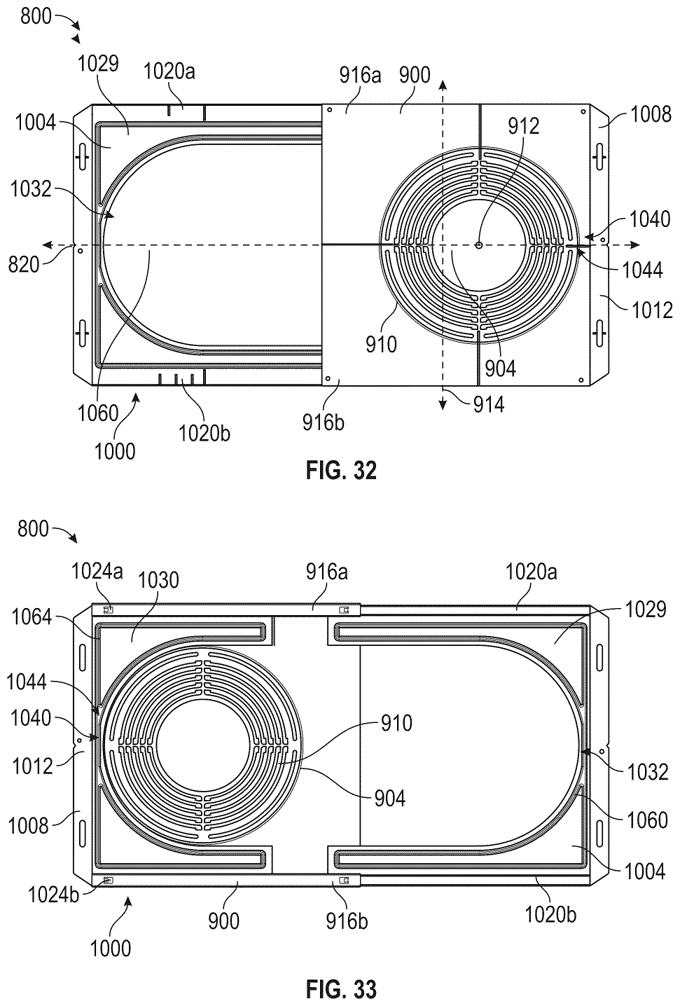

FIGS. 32 and 33 illustrate the support assembly 800 in an eleventh configuration. In the eleventh configuration, the knockouts 904 may be received by a second blind end 1044 of the second bracket member 1008. As illustrated in FIGS. 32 and 33, the asymmetrical centerplate 900 includes the center point 912, which is offset on the centerplate 900 in a direction that is towards the building structure 816. The offset orientation of the center point 912 may therefore allow the plurality of knockouts 904 to be positioned closer to the building structure 816 than in conventional approaches. For example, the offset of the center point 912 may permit a center of the equipment 804 extending through the knockouts 904 to be positioned less than about 5.5 inches from an edge of the building structure 816, farther away than the existing support brackets discussed above, but closer than conventional light assembly support brackets.

Thus, examples of the disclosed technology can provide improved systems for telescopically supporting electrical equipment between building structures including assemblies with lighting assemblies, or electrical devices of various kinds, including electrical boxes, light fixtures (e.g., luminaires), fans, low voltage devices (e.g., outlets, switches, and other low voltage devices), and any other electrical device that can be mounted on a building structure. Some examples provide a support assembly that is inexpensive to manufacture while providing an improved mechanism for telescopically adjusting an extension length of a support assembly during installation.

Also as used herein, the use of “including,” “comprising,” or “having” and variations thereof is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

Also as used herein, unless otherwise limited or defined, “substantially identical” indicates that features or components are manufactured using the same processes according to the same design and the same specifications. In some cases, substantially identical features can be geometrically congruent.

Also as used herein, unless otherwise limited or defined, “substantially centered” indicates that a center of a feature or component relative to a reference direction is within 10% of center of another feature or component relative to the reference direction. For example, for a body having a length L relative to a first direction, a feature that is substantially centered on the body along a first direction has a center that is located at a distance of within 0.1*L of a midpoint of the body along the first direction. In contrast, unless otherwise limited or defined, “offset” indicates that a center of a feature or component is not substantially centered on another component.

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

Unless otherwise limited or defined, “substantially parallel” indicates a direction that is within ±12 degrees of a reference direction (e.g., within ±6 degrees or ±3 degrees), inclusive. Correspondingly, “substantially vertical” indicates a direction that is substantially parallel to the vertical direction, as defined relative to gravity, with a similarly derived meaning for “substantially horizontal” (relative to the horizontal direction). Likewise, unless otherwise limited or defined, “substantially perpendicular” indicates a direction that is within ±12 degrees of perpendicular a reference direction (e.g., within ±6 degrees or ±3 degrees), inclusive.

Also as used herein, unless otherwise defined or limited, directional terms are used for convenience of reference for discussion of particular figures or examples or to indicate spatial relationships relative to particular other components or context, but are not intended to indicate absolute orientation. For example, references to downward, forward, or other directions, or to top, rear, or other positions (or features) may be used to discuss aspects of a particular example or figure, but do not necessarily require similar orientation or geometry in all installations or configurations. Thus, for example, a front view of an assembly in a particular figure may be a bottom view in an installed configuration, etc.

Unless otherwise specifically indicated, ordinal numbers are used herein for convenience of reference, based generally on the order in which particular components are presented in the relevant part of the disclosure. In this regard, for example, designations such as “first,” “second,” etc., generally indicate only the order in which a thus-labeled component is introduced for discussion and generally do not indicate or require a particular spatial, functional, temporal, or structural primacy or order.

In some implementations, devices or systems disclosed herein can be utilized, manufactured, or installed using methods embodying aspects of the invention. Correspondingly, any description herein of particular features, capabilities, or intended purposes of a device or system is generally intended to include disclosure of a method of using such devices for the intended purposes, of a method of otherwise implementing such capabilities, of a method of manufacturing relevant components of such a device or system (or the device or system as a whole), and of a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

1. A support bracket to support a lighting assembly relative to building structures, the support bracket comprising:
a centerplate that integrally includes: a support portion with an opening to receive the lighting assembly, a first centerplate rail extending along an extension direction, and a second centerplate rail extending along the extension direction;
a first bracket member that integrally includes: a first mounting flange configured to secure the first bracket member to a first building structure, a first bracket rail extending from the first mounting flange in the extension direction to slidably nest with the first centerplate rail, and a second bracket rail extending from the first mounting flange in the extension direction to slidably nest with the second centerplate rail; and
a second bracket member that integrally includes: a second mounting flange configured to secure the second bracket member to a second building structure, a third bracket rail extending from the second mounting flange in the extension direction to slidably nest with the first centerplate rail, and a fourth bracket rail extending from the second mounting flange in the extension direction to slidably nest with the second centerplate rail;
the first and third bracket rails being slidably movable within the first centerplate rail, and the second and fourth bracket rails being slidably movable within the second centerplate rail, to provide a range of extension lengths of the support bracket to support the centerplate between the first building structure and the second building structure.

2. The support bracket of claim 1, wherein the first bracket member and the second bracket member are slidably adjustable, within the first and second centerplate rails, to a first installed orientation to support the lighting assembly; and
wherein, in the first installed orientation, free ends of the first and second bracket rails are spaced apart along the extension direction from free ends of the third and fourth bracket rails, within the first and second centerplate rails, respectively.

3. The support bracket of claim 2, wherein the first installed orientation corresponds to a maximum installed spacing between the first and second building structures.

4. The support bracket of claim 3, further comprising:
tabs extending from one or more of the first centerplate rail, the first bracket rail, or the third bracket rail to define stops against telescoping extension of telescoping support bracket beyond the first installed orientation.

5. The support bracket of claim 4, wherein the tabs are included on each of the first centerplate rail, the first bracket rail, and the third bracket rail.

6. The support bracket of claim 3, wherein the first bracket member and the second bracket member are slidably adjustable from the first installed orientation to a second installed orientation, the second installed orientation corresponding to a minimum installed spacing between the first and second building structures; and
wherein, in the second installed orientation, the free ends of the first and second bracket rails are not nested together along the extension direction.

7. The support bracket of claim 2, wherein, in the first installed orientation, the first bracket rail extends a first distance into the first centerplate rail along the extension direction and the third bracket rail extends a second distance into the first centerplate rail along the extension direction, the second distance being smaller than the first distance.

8. The support bracket of claim 7, wherein the first bracket rail extends within the first centerplate rail across a centerline of the centerplate that extends perpendicular to the extension direction.

9. The support bracket of claim 1, wherein the first bracket member includes the first bracket rail extending integrally from a first side of the first mounting flange, and
wherein the first bracket member includes the second bracket rail extending integrally from a second side of the first mounting flange, opposite the first side, to extend along an opposite side of the lighting device than the first bracket rail.

10. The support bracket of claim 9, wherein the first bracket member includes a first wall extending between the first bracket rail and the second bracket rail, the first wall including a cutout that defines a width that is greater than or equal to a diameter of the opening.

11. The support bracket of claim 10, wherein the first wall includes an embossment, the embossment defining an indentation that extends away from the centerplate.

12. The support bracket of claim 1, wherein the first bracket rail and the third bracket rail each define a respective elongated tube.

13. The support bracket of claim 12, wherein the first centerplate rail defines an elongated tube that slidingly receives the respective elongated tubes of the first and third bracket rails.

14. The support bracket of claim 1, wherein the opening is defined by a removable ring of a plurality of removable rings included on the support portion of the centerplate; and
wherein a rear face of the removable ring is offset relative to a rear face of the support portion that surrounds the plurality of removable rings.

15. The support bracket of claim 1, wherein the first centerplate rail and the second centerplate rail each define an elongated tube, wherein the first centerplate rail extends along a first side of the centerplate, and the second centerplate rail extends along a second side of the centerplate, opposite the first side, and wherein the first and second sides of the centerplate are the longest sides of the centerplate.

16. A support bracket to support a lighting assembly, the support bracket comprising:
a centerplate including:
a support portion that includes a knockout, the knockout being selectively removable to define an opening to receive the lighting assembly; and
a first centerplate rail, the first centerplate rail including a first rectangular tube section extending along the support portion in an extension direction; and
a telescoping support assembly including:
a first bracket member including a first bracket rail, the first bracket rail including a second rectangular tube section nested with the first rectangular tube section of the first centerplate rail along the extension direction, the first bracket rail being slidably movable relative to the first centerplate rail along the extension direction to adjust a first offset of the lighting assembly from a first building structure; and
a second bracket member including a second bracket rail, the second bracket rail including a third rectangular tube section nested with the first rectangular tube section of the first centerplate rail, the second bracket rail being slidably movable relative to the first centerplate rail along the extension direction to adjust a second offset of the lighting assembly from a second building structure.

17. The support bracket of claim 16, wherein a first end of the first bracket rail provides a contact stop for the second centerplate rail within the first centerplate rail.

18. The support bracket of claim 16, wherein in a first configuration, a first length of the first bracket rail is nested within the first centerplate rail and a second length of the second bracket rail is nested within the first centerplate rail, the first length being larger than the second length.

19. A method of supporting a lighting assembly relative to a building structure, the method comprising:
supporting the lighting assembly in an opening of a support portion of a centerplate of a support bracket, the centerplate further including a first centerplate rail extending along an extension direction, and a second centerplate rail extending along the extension direction;
slidably nesting a first bracket rail of a first bracket member of the support bracket with the first centerplate rail and slidably nesting a second bracket rail of the first bracket member with the second centerplate rail, the first bracket member integrally including a first mounting flange configured to secure the first bracket member to a first building structure, the first bracket rail extending from the first mounting flange in the extension direction to slidably nest with the first centerplate rail, and the second bracket rail extending from the first mounting flange in the extension direction to slidably nest with the second centerplate rail;
slidably nesting a third bracket rail of a second bracket member of the support bracket with the first centerplate rail and slidably nesting a fourth bracket rail of the second bracket member with the second centerplate rail, the second bracket member integrally including a second mounting flange configured to secure the second bracket member to a second building structure, the third bracket rail extending from the second mounting flange in the extension direction to slidably nest with the first centerplate rail, and a fourth bracket rail extending from the second mounting flange in the extension direction to slidably nest with the second centerplate rail; and
slidably moving the first and third bracket rails within the first centerplate rail, and the second and fourth bracket rails within the second centerplate rail, to provide an extension length selected from a range of extension lengths of the support bracket, to support the centerplate between the first building structure and the second building structure.

20. The method of claim 19, further comprising:
slidably adjusting the first and second bracket members relative to the centerplate to any of a plurality of installed orientations between a first installed orientation and a second installed orientation, the first installed orientation corresponding to a maximum extension length of the range of extension lengths, and the second installed orientation corresponding to a minimum extension of the range of extension lengths;
wherein in the first installed orientation, there is a first gap along the extension direction between free ends of the first and third bracket rails, within the first centerplate rail.
